(19) United States
(12) Patent Application Publication
(10) Pub. No.: US 2019/0073040 A1
(43) Pub. Date: Mar. 7, 2019

(54) GESTURE AND MOTION BASED CONTROL OF USER INTERFACES

(71) Applicant: Future Mobility Corporation Limited, Hong Kong (HK)

(72) Inventors: Wolfram Luchner, Los Altos Hills, CA (US); Jacob Pennock, San Jose, CA (US); Eric Veit, Cupertino, CA (US)

(21) Appl. No.: 15/696,022

(22) Filed: Sep. 5, 2017

(51) Int. Cl. G06F 3/01; G06K 9/00; G06F 3/0484; B60K 37/06

(52) U.S. Cl. CPC G06F 3/017; G06K 9/00355; G06F 3/04847; B60K 37/06; B60K 2350/1068; B60K 2350/1004; B60K 2350/1052; B60K 2350/2013; B60K 2350/106; G06F 3/016

(57) ABSTRACT

Embodiments are disclosed of an apparatus including a digital camera to capture video or a sequence of still images of a user's hand. One or more processors are coupled to the digital camera to process the video or the sequence of still images to produce a digital representation of the user's hand, to determine the gesture and motion of the user's hand from the digital representation, and to correlate the gesture or the gesture/motion combination to a user interface command. A user interface controller is coupled to receive the user interface command from the one or more processors. A display is coupled to the user interface controller. The user interface controller causes a set of one or more user interface controls to appear on the display. The user interface command selects or adjusts one or more of the set of displayed user interface controls, and motion of the selected user interface control tracks the motion of the user's hand in substantially real time. Other embodiments are disclosed and claimed.

### TECHNICAL FIELD

The disclosed embodiments relate generally to user interfaces and more specifically, but not exclusively, to touchless interaction with a user interface using gestures and gesture/motion combinations.

### BACKGROUND

As electronics have proliferated, ways of controlling them and their attributes have improved substantially. Originally, most electronics were controlled using physical controls—knobs, sliders, buttons, etc. Nowadays, many electronics are controlled by software, but in many cases they still require some sort of direct or indirect physical touch by a user; examples include pointing and clicking with a mouse and selecting or manipulating items on a touch screen or touch pad. Disadvantages of these methods of control include that the user must usually pay attention to the device in question, thus distracting attention from other tasks, and that the user must be able to touch a physical control device, which might be difficult if the physical control device is inconveniently placed.

### SUMMARY

The disclosure discussed embodiments of an apparatus and method for gesture- and motion-based control of user interfaces. The apparatus includes a digital camera to capture video or a sequence of still images of a user's hand. One or more processors are coupled to the digital camera to process the video or the sequence of still images to produce a digital representation of the user's hand, to determine the gesture and motion of the user's hand from the digital representation, and to correlate the gesture or the gesture/motion combination to a user interface command. A user interface controller is coupled to receive the user interface command from the one or more processors. A display is coupled to the user interface controller. The user interface controller causes a set of one or more user interface controls to appear on the display. The user interface command selects or adjusts one or more of the set of displayed user interface controls, and motion of the selected user interface control tracks the motion of the user's hand in substantially real time.

The method includes capturing video or a sequence of still images of a user's hand. The video or sequence of still images are processed to produce a digital representation of the user's hand, to determine the gesture and motion of the user's hand from the digital representation, and to correlate the gesture or the gesture/motion combination to a user interface command. A set of one or more user interface controls appears on a display. The user interface command selects or adjusts one or more of the set of displayed user interface controls, and motion of the selected user interface control tracks the motion of the user's hand in substantially real time.

### BRIEF DESCRIPTION OF THE DRAWINGS

Non-limiting and non-exhaustive embodiments are described with reference to the following figures, wherein like reference numerals refer to like parts throughout the various views unless otherwise specified.

FIGS. 1A-1B are block diagrams of embodiments of user interface systems that can be interacted with using gestures and gesture/motion combinations.

FIG. 2 is a flowchart of an embodiment of operation of the user interface systems illustrated in FIGS. 1A-1B.

FIGS. 3A-3C are diagrams of embodiments of an automotive application of user interface systems such as the ones illustrated in FIGS. 1A-1B.

FIGS. 4A-4E are diagrams of an embodiment of operation of a user interface system using gestures and gesture/motion combinations.

FIGS. 5A-5D are diagrams of another embodiment of operation of a user interface system using gestures and gesture/motion combinations.

FIGS. 6A-6D are diagrams of embodiments of interaction to change the number or size of software-defined displays.

FIGS. 7A-7C are diagrams of an embodiment of user interaction with multiple displays.

FIGS. 8A-8C are diagrams of embodiments of user interaction to select information from a display.

FIGS. 9A-9D are diagrams of embodiments of user interaction to select and delete information from a display.

FIGS. 10A-10C are diagrams of embodiments of user interaction to rotate a three-dimensional interface shown on a display.

FIG. 11 is a diagram of an embodiment of user interaction to zoom in and zoom out items shown on a display.

FIG. 12 is a diagram of an embodiment of user interaction to activate and deactivate a gesture recognition system.

### DETAILED DESCRIPTION OF THE ILLUSTRATED EMBODIMENTS

Embodiments are described of an apparatus, system and method for touchless interaction with a user interface using gestures or gesture/motion combinations. Specific details are described to provide an understanding of the embodiments, but one skilled in the relevant art will recognize that the invention can be practiced without one or more of the described details or with other methods, components, materials, etc. In some instances, well-known structures, materials, or operations are not shown or described in detail but are nonetheless within the scope of the invention.

Reference throughout this specification to “one embodiment” or “an embodiment” means that a described feature, structure, or characteristic can be included in at least one described embodiment, so that appearances of “in one embodiment” or “in an embodiment” do not necessarily all refer to the same embodiment. Furthermore, the described features, structures, or characteristics may be combined in any suitable manner in one or more embodiments.

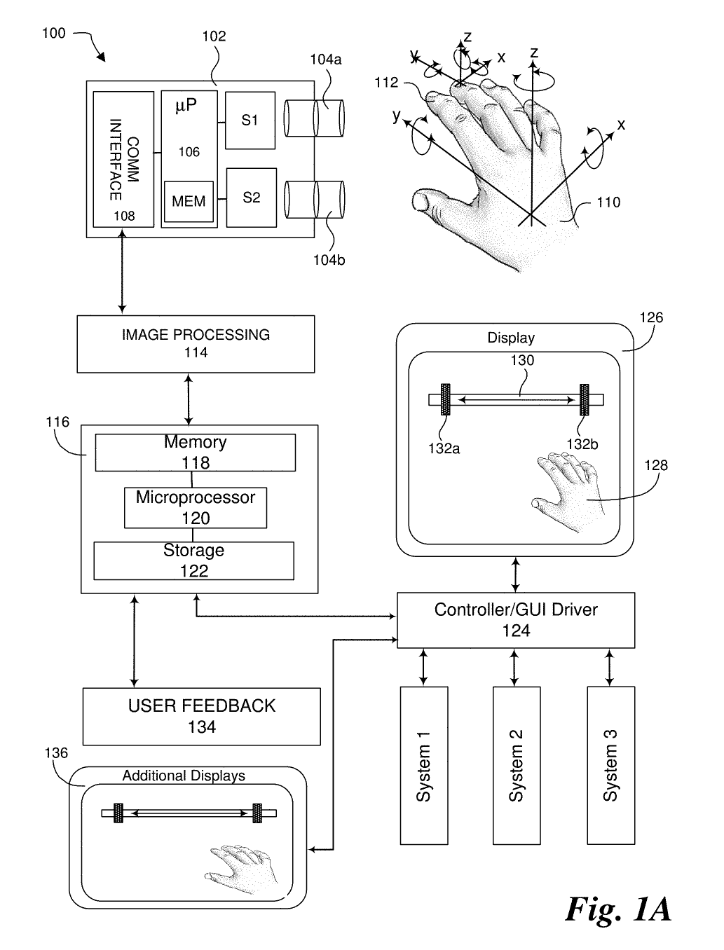

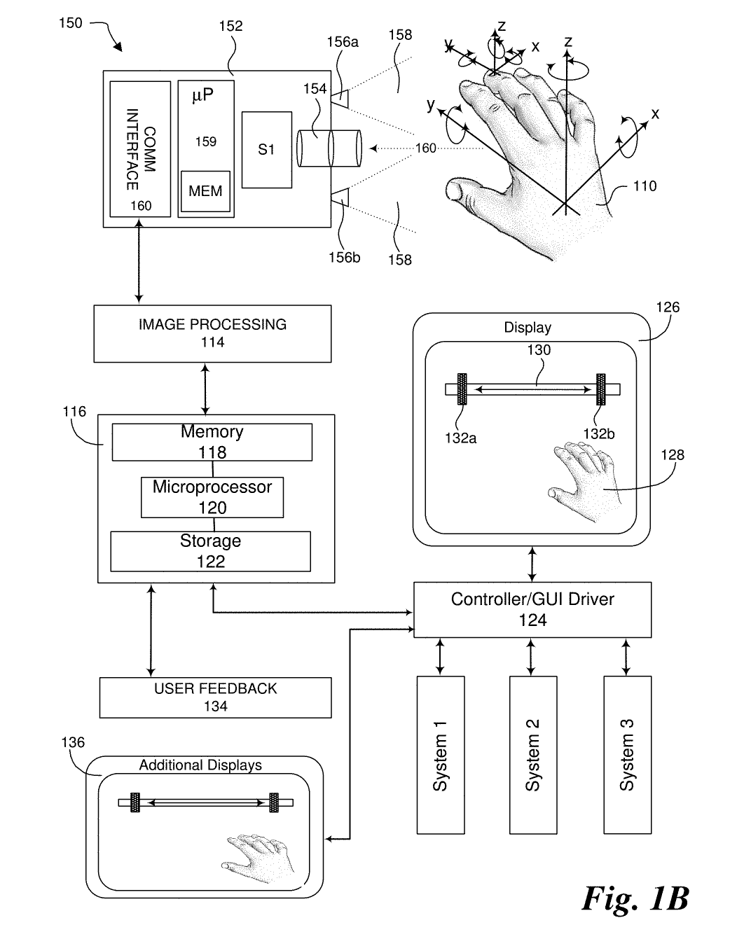

FIG. 1A illustrates an embodiment of a user interface system 100 in which gestures or gesture/motion combinations of one or more human body parts allow a user to interact with the user interface and, through the user interface, to control one or more underlying systems. In the illustrated embodiments, the human body part is a human hand, but in other embodiments gesturesor gesture/motion combinations of other body parts, such as the head or face, can also be used. Still other embodiments can use gestures and gesture/motion combinations of multiple body parts.

System 100 includes a camera 102 communicatively coupled to an image processor 114. Image processor 114 is in turn communicatively coupled to a computer 116, and computer 116 is further communicatively coupled to a controller/graphic user interface (GUI) driver 124. Controller/GUI driver 124 is then further communicatively coupled to a display 126, one or more underlying systems 1-3, and in some embodiments to one or more additional displays 136.

Camera 102 is a RGB stereoscopic camera including a pair of spaced-apart lenses 104a-104b that work together to create a stereoscopic image or video of an object such as human hand 110. Lenses 104a-104b are spaced apart so that each lens has a slightly different viewpoint of hand 110; the different viewpoints of hand 110 are needed to be able to provide a stereoscopic (i.e., three-dimensional) image of the hand. Each lens 104a-104b is optically coupled to an image sensor so that each lens focuses an image onto its corresponding image sensor: sensor S1 is optically coupled to lens 104a and sensor S2 is optically coupled to lens 104B. Sensors S1 and S2 are communicatively coupled to a microprocessor 106, which is in turn coupled to a communication interface 108, through which camera 102 can transmit captured video or still images to image processor 114. A suitable commercially available stereoscopic camera that can be used as camera 102 is the RealSense line of cameras manufactured by Intel Corporation of Santa Clara, Calif.

Image processor 114 and computer 116 together process images received from camera 102 to determine the gesture or gesture/motion combination of user's hand 110. In the illustrated embodiment image processor 114 and computer 116 are shown as separate components, but in other embodiments image processor 114 and computer 116 can be embodied in the same component; for instance, in another embodiment image processor 114 and computer 116 can be different processes running on a single computer—that is, running on a single piece of hardware.

In the illustrated embodiment image processor 114, having received images or video from camera 102, can process the images or video to produce a digital representation of user's hand 110. For instance, software running on image processor 114 can identify certain strategic portions of the hand, such as knuckles or other joints in one embodiment, and create a digital representation of the hand based on the locations of these strategic portions. Japan. Having created a digital representation of the gesture of hand 110, image processor 114 can then, based on the digital representation, identify the gesture or gesture/motion combination, made by hand 110. Alternatively, gesture identification can be performed by computer 116 or can be performed partially by image processor 114 and partially by computer 116. Suitable commercially available software that can create the digital representation and identify the gesture includes the SoftKinetic software created by Sony Corp. of Tokyo,

For purposes of this application, the gesture of a hand, for instance, refers to the relative positions of the different parts of the hand. Motion of the hand refers to any of: linear translation of the hand in the X, Y, or Z directions; angular rotation of the hand about any of the X, Y, or Z axes; translation or rotation of any part of the hand, such as index finger 112, along or about the X, Y, or Z axes; linear or angular motion-related quantities such as velocity, acceleration, rate of change of acceleration, of hand 110 or any part of hand; or lack of motion of the hand or any part of the hand.

Computer 116 is communicatively coupled to image processor 114 and includes a microprocessor 120 which is communicatively coupled to both a memory 118 and storage 122. In one embodiment, computer 116 can receive the digital representation of the hand from image processor 114 then analyze that digital representation to identify the gesture or gesture/motion combination made by hand 110. Having identified the gesture or gesture/motion combination, computer 116 can then try to associate the identified gesture or gesture/motion combination to a user interface command. This can be done, for instance, by comparing the identified gesture or gesture/motion combination to known gesture and gesture/motion combinations stored in a library, a database, a lookup table, or other search and association mechanism stored in memory 118 or storage 122. If the gesture or gesture/motion identification has been previously done by a separate image processor 114, then computer 116 can simply receive information from the image processor and use it directly to associate the identified gesture or gesture/motion combination to a user interface command. In other embodiments, the system can “learn” and adapt rather than strictly perform a match and compare algorithm to identify gestures. For instance, even if there is a database and library, the system can still learn to distinguish individual patterns and modify the database to add information about the individual patterns to improve accuracy.

Controller/GUI driver 124 is communicatively coupled to computer 116 to receive user interface commands that computer 116 has determined correspond to the gesture or gesture/motion combination made by hand 110. Although in the illustrated embodiment it is shown as a separate component, in other embodiments the functions of controller/GUI driver 124 can be incorporated into and performed by computer 116. Controller/GUI driver 124 is also coupled to display 126, which can display a set of one or more graphic user interface controls that can then be selected, manipulated, or otherwise interacted with based on the user interface commands received from computer 116. In some embodiments controller/GUI driver 124 can also be coupled to one or more additional displays 136. In an embodiment with additional displays 136, different displays can show the same or different user interface control sets and gestures or gesture/motion combinations can be used to transfer control from one display to another.

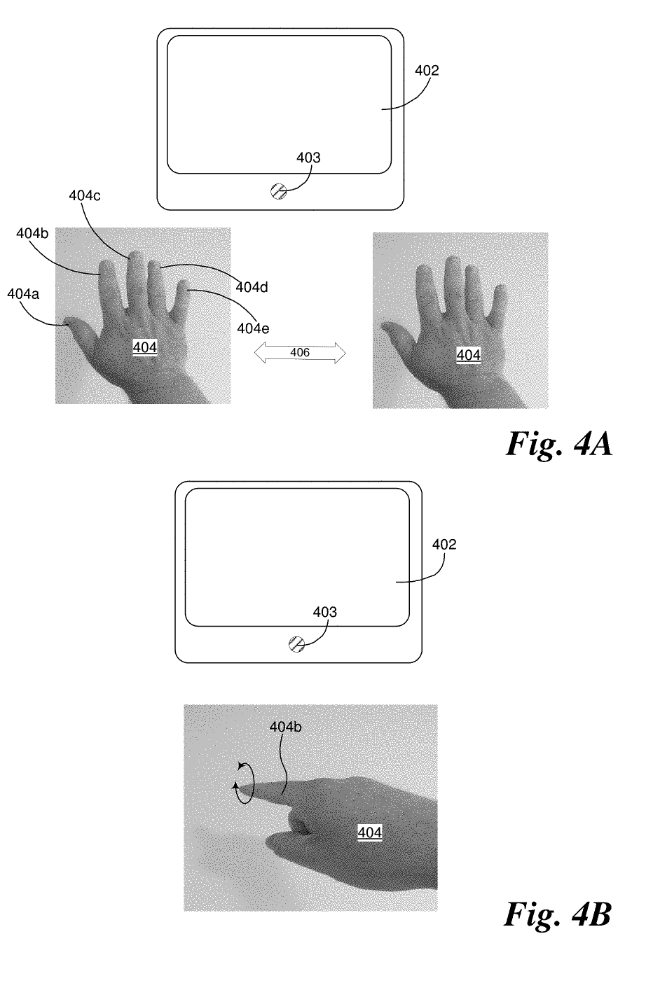

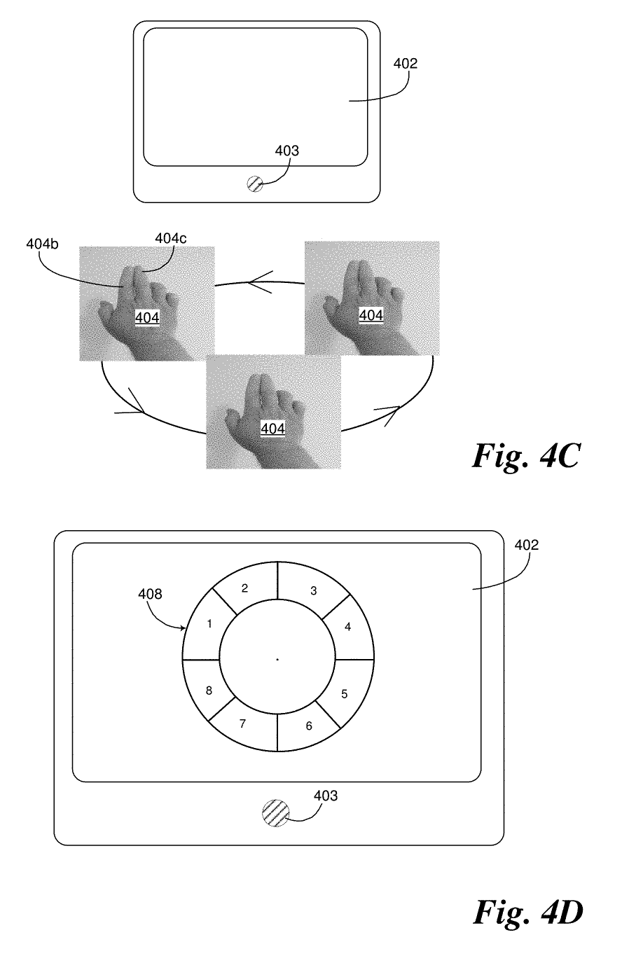

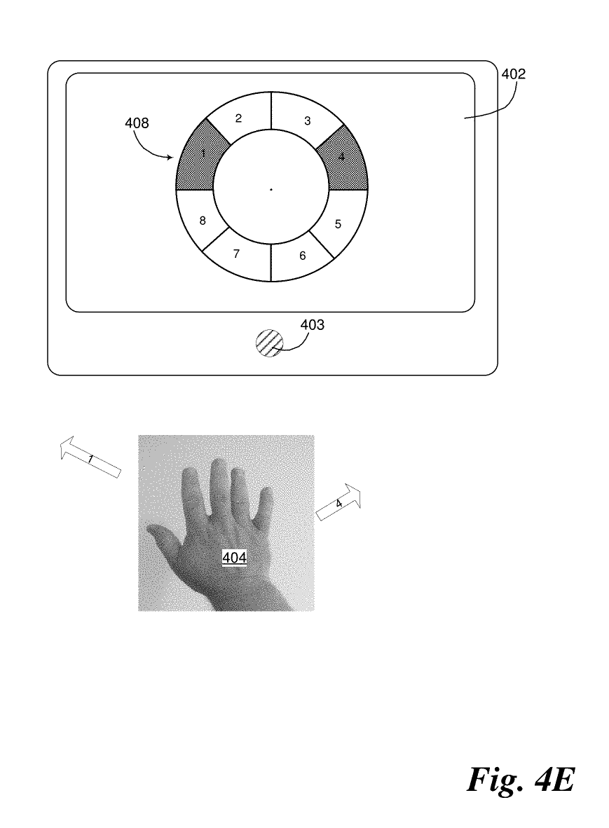

The graphic user interface controls shown on display 126 can be context dependent; that is, the particular set of user interface controls shown on display 126 can depend on the system for which they are being used, or the function for which they are being used within a particular system. In the illustrated embodiment, the graphic user interface control is a slider 130 over which a handle 132 can be moved from position 132a to position 132b, by the correct gesture and motion of hand 110 to alter some attribute of an underlying system. Such a graphic user interface control could be useful, for instance, in an embodiment in which a sound system volume is adjusted from one value to another. A different set of graphic user interface controls—multiple sliders 130, for instance, or some other type of control (see, e.g., FIGS. 4A-10)—could be used when adjusting multiple sound qualities such as bass, treble, balance, fade, etc., of the sound system. In some embodiments, a graphic representation 128 of the gesture made by hand 110 can be displayed on display 126 and on additional displays 136, if present, and its motion on the screen can track the actual motion of hand 110 to provide visual user feedback. User interface controls such as a visible cursor, can be provided instead of or in addition to other controls to provide different or additional visual user feedback.

System 100 allows a user to interact with the user interface controls shown on a display using gestures, while providing substantially real-time feedback to the user. Among other things, the substantially real-time feedback is provided by having the motion of items displayed on the screen, such as user interface controls, have a relationship to the motion of the gesture/motion combination of the hand. In the slider embodiment discussed above, for instance, a gesture could cause a cursor to appear on the screen. That cursor's motion on the screen would then track the hand's motion in real time to help the user get to and select the slider. Once the slider is selected, then the slider's motion in moving from position 132a to 132b can also track the motion of the user's hand to provide real-time visual feedback to the user. Numerous other examples of gesture/motion interaction with user interface controls and displays are shown in the figures and discussed below.

User feedback device 134 is communicatively coupled to computer 116 to allow feedback to be provided to the user other than through displays 126 and 136. For instance, in various embodiments, if the gesture or gesture/motion combination of hand 110 was not recognized by image processor 114, or cannot be correlated to a known user interface control by computer 116, feedback device 134 can alert the user of certain conditions, such as: that the gesture was not recognized and must be reentered; that the gesture was recognized but the command was unsuccessful; that an action is confirmed; etc. In one embodiment, user feedback device 134 can provide visual (e.g., a light or other visual indicator) or auditory (i.e., sound) feedback to the user, but in other embodiments user feedback device 134 can provide haptic feedback, such as vibration, to a part of the user's body. In an automobile, for instance, user feedback device 134 can be a vibration mechanism positioned in the back of the driver's seat to provide vibration to the driver's back as feedback.

Underlying systems 1-3 are also coupled to controller/GUI driver 124. Although only three systems are shown in the illustrated embodiment, other embodiments can have more or less systems than shown. Systems 1-3 are the systems whose attributes are being controlled by the interaction of the hand's gesture or gesture/motion combination with the user interface controls displayed by controller/GUI driver 124 on displays 126 and 136. For instance, in an automobile embodiment system 1 could be a sound system whose volume is being adjusted with gestures and motions that interact with slider 130 shown on the display. In an automobile embodiment, systems 1-3 can include a sound system, a navigation system, a telephone system, or automobile systems such as those that control steering, suspension, air-conditioning, interior lighting, exterior lighting, locking, battery management, power management, and so on.

FIG. 1B illustrates another embodiment of a control system 150. Control system 150 is similar in most respects to control system 100. The primary difference between control system 100 and 150 is that control system 150 replaces stereoscopic camera 102 with a time-of-flight camera 152. Time-of-flight camera 158 includes a single lens 154 optically coupled to an image sensor S1. One or more radiation sources 156a-156b direct radiation 158 toward hand 110. Sensor S1, together with processor 159, measure the delay of the reflected radiation 160 to determine the time of flight of the radiation. Processor 159 can then use the time-of-flight information to create a three-dimensional image or video of hand 110. Suitable commercially available time-of-flight cameras that can be used in embodiments of control system 150 include those available from Melexis Nev. of Belgium or its affiliates.

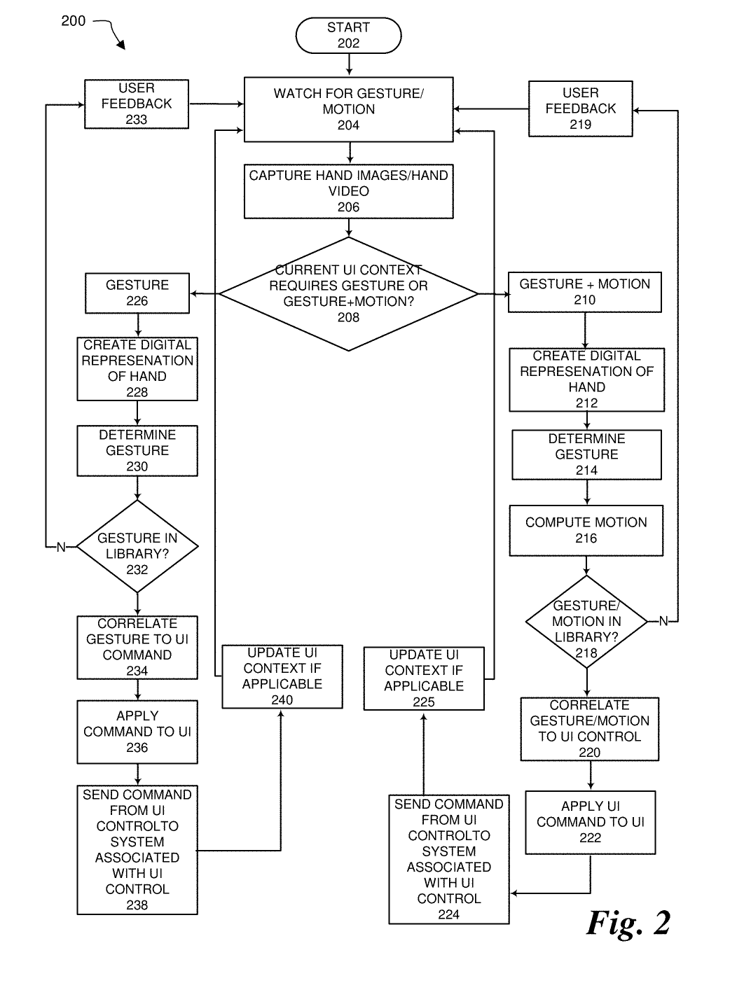

FIG. 2 illustrates an embodiment of a process 200 by which systems 100 and 150 can operate. Process 200 starts at block 202. At block 204, the camera is activated and is put in a state in which it watches for gestures and/or motions to appear within its field of view and within its depth of field.

At block 206, the camera captures video, a still image, or a series of still images of the user's hand. A block 208, the process determines whether the current user interface (UI) context requires gesture only or gesture/motion combination. If at block 208 the process determines that the current user interface context requires gesture and motion, the process proceeds to block 210 and then to block 212 where the process creates a digital representation of the user's hand.

At block 214, the process determines the gesture based on the digital representation of the hand created a block 212, and at block 216 the process computes the motion of the hand, also based on the digital representation created at block 212. At block 218, the process examines whether the gesture/motion combination is found in a library of gestures that are associated with user interface controls in the current UI context.

If at block 218 the process determines that the gesture/motion combination is not in a current library the process proceeds to block 219, where it provides user feedback indicating that the gesture/motion combination was not found or not accepted, and then returns to block 204 where it watches for a further gesture and/or motion. But if at block 218 the process determines that the gesture/motion combination is indeed found in the library, it proceeds to block 220 where it correlates or associates the gesture/motion to a command for a UI control within the set of displayed UI controls. At block 222, the process transmits the UI command to the applicable user interface control, updates the UI control accordingly, and then proceeds to block 224. At block 224 a command is sent from the user interface controller to the system associated with the user interface control that has just been activated or manipulated. Then the process proceeds to block 225 which updates the user having interface context if applicable and then returns the block 204 where watches for further gesture and/or motion from the user.

If at block 208 the process determines that the current user interface context requires only gestures, then the process proceeds to block 226. At block 228 the process creates a digital representation of hand 110 and at block 230 the process determines the gesture formed by the hand based on the digital representation created at block 228. A block 232 the process determines whether the gesture determined in block 230 exists in the current gesture library. If at block 232 the process determines that the gesture is not in the current library then the process proceeds to block 233 where it provides feedback to the user indicating that the gesture was not accepted and that a new attempt is required.

If at block 232 the process determines that the gesture is indeed in a current gesture library, then it proceeds to block 234 where it correlates or associates the gesture to a user interface command associated with a currently displayed user interface control. At block 236 the user interface command is applied to the user interface control and at block 238 a command is sent by the user interface controller to the system associated with the user interface control that has just been activated or manipulated. In the previous automobile example of adjusting sound system volume, at block 238, having adjusted the slider to the correct volume, that information is then sent to the underlying sound system to actually adjust the volume. The system then proceeds to block 240 where the UI context is updated if applicable and then returns to block 204 where watches for further gestures.

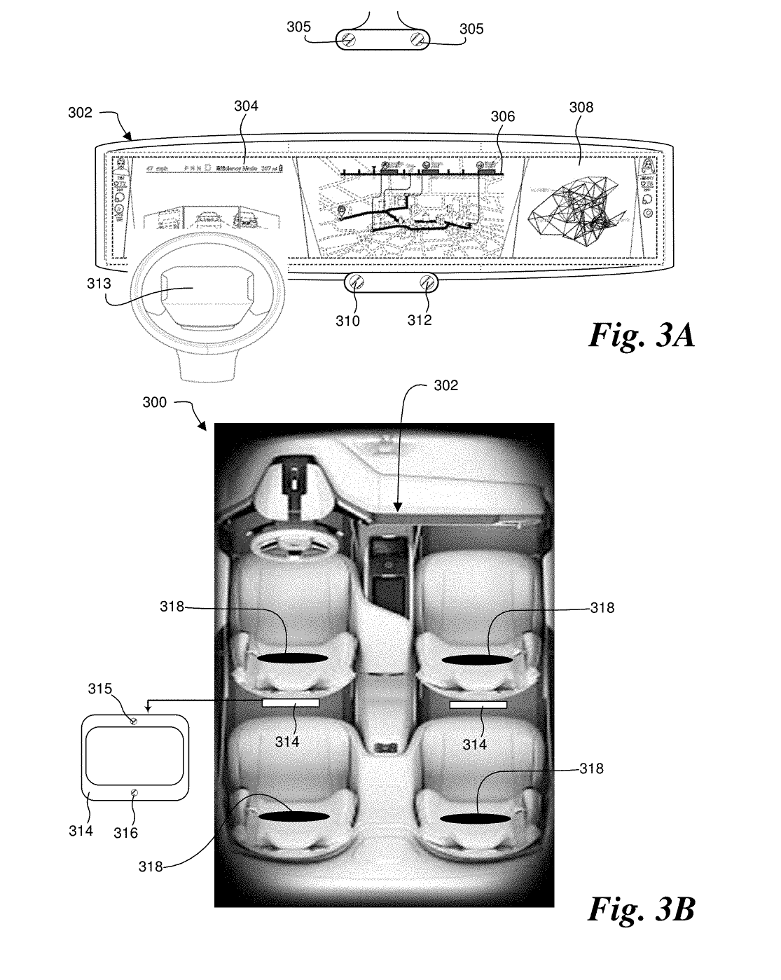

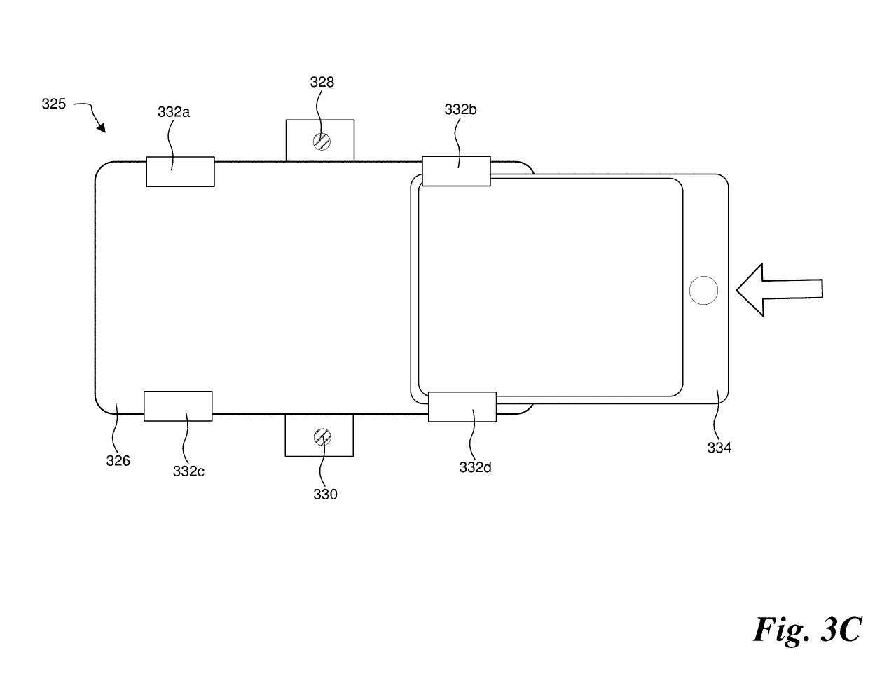

FIGS. 3A-3B illustrate an automotive embodiment of user interface systems 100 or 150. FIG. 3A illustrates an automobile dashboard 302 which includes a plurality of displays. In the illustrated embodiment dashboard 302 includes a single display which can be configured to display different things in three software-configurable display regions 304, 306, and 308, but in other embodiments dashboard 302 can have a different number of display regions than shown and in still other embodiments regions 304, 306, and 308 can be physically separate displays. In the illustrated embodiment, software-configurable display region 306 can show an interactive map with which the driver and passengers can interact with gestures. Dashboard 302 also includes hand gesture recognition cameras 310 and 312 positioned below display regions 304, 306, and 308, where they can capture video or images of a at least one of the driver's hands and both hands or a front passenger. A display 313 can be positioned in the center of the steering wheel to act as a user input device and to provide additional display capabilities for the driver.

Facial cameras 305 can also be positioned in the cabin, for instance where a rear-view mirror is or, if not present, where it normally would be, to capture video or still images of a driver and front passenger's faces. Cameras 305 can be used for facial recognition or can be used for gesture recognition systems that support facial gesture or motion recognition. For instance, in one embodiment cameras 305 can use facial recognition to identify an authorized user of the car. In other embodiments, cameras 305 can be used to recognize certain user head motions—nodding to indicate approval (i.e., “yes”) or rotating the head from side-to-side to indicate disapproval (i.e., “no”). Still other embodiments can use interaction between hand gestures and head motions. For instance, hand gestures can be used to select an item from a user interface and then a head motion can be used to approve or disapprove the selection. In still other embodiments, recognition of head motion can be selectively turned on and off, for instance by the gesture recognition system if head motions are not relevant in the current user interface context or by the user if they don't want to use head motions.

The different components described are coupled to each other substantially as in systems 100 or 150 to provide the gesture recognition functionality within the automobile interior. The other elements of systems 100 or 150 can be put elsewhere in the car, for instance in the dashboard or in the trunk.

FIG. 3B is a plan view of an automobile interior 300. Automobile interior 300 includes dashboard 302 and also includes a driver's seat, a front passenger seat, and two rear passenger seats. As described above displays 304, 306, and 308 in dashboard 302 provide displays for persons seated in the driver's seat and the front passenger seat. To provide displays for persons sitting in the rear passenger seats, rear passenger displays 314 can be positioned in the backs of the driver's seat and the front passenger seat. Each rear passenger display 314 includes a display unit, a facial camera 315 to capture selfies or facial gestures and motions, and a hand camera 316 to capture hand gestures and motions of each passenger

A feedback mechanism 318 is positioned in the back of the driver's seat, as well as in the back of the front passenger seat and the backs of the rear passenger seats to provide haptic feedback to the user regarding the use of the gestures system. Each person occupying a seat in the car can thus control their own display via gestures, be they hand gestures, facial gestures, etc. To prevent driver confusion, the haptic feedback provided for the gesture control system by feedback mechanism 318 can be different from other haptic feedback in the car. For instance, if a lane assist system provide vibration feedback, then feedback system 318 can provide a sharp tap (also known as taptic feedback) to the user, such as a user might feel if struck by a small hammer. Different tapping patterns can be used to confirm different conditions, such as a successful (or unsuccessful) action initiated by facial or hand gesture.

FIG. 3C illustrates an embodiment of a display 325 that can be used, for instance, as a rear passenger display within automobile interior 300. Display 325 can be mounted to the back of a front seat and allows the rear passenger to use their own tablet computer as a display. In other words, display 325 combines a display bracket 326 with a separate tablet computer 334 to form a display in the back of the seat.

Display 325 includes a display bracket 326 and a plurality of clamps 332a-332d. Also coupled to bracket 326 are a pair of cameras: a facial camera 328 and a hand camera 330. Facial camera 328 can be used by a rear passenger for selfies, for facial gesture recognition, or for facially-related biometric functions, while hand camera 330 can be used to detect hand gestures and motion from a rear passenger to control the respective display. To provide display for the rear seat passenger, the passenger can insert a tablet computer 334 into bracket 326, where it is held in place by tabs 332a-332d. Although not shown in the figure, bracket 326 also provides the electrical and communication connections needed for tablet computer 334 to communicate with user interface system 100 or 150.

FIGS. 4A-4E illustrate an embodiment of using gestures and motion to activate and use a particular user interface control. FIGS. 4A-4C illustrate gesture/motion combinations that can be used to activate a user interface control on display 402. A hand 404 that includes thumb 404a, index finger 404b, middle finger 404c, ring finger 404d, and pinky finger 404e is held with all fingers fully extended and the palm or back of the hand substantially parallel to display 402 and then moved from side to side in the field of view of camera 403, as indicated by arrow 406, to activate the user interface control.

FIG. 4B illustrate another embodiment of activating a user interface control on display 402. In hand 404, index finger 404b is held extended while middle, ring, and pinky fingers 404c-404d are retracted. The end of index finger 404b, alone or together with the rest of hand 404, is moved in a circular motion for camera 432 activate the display.

FIG. 4C illustrates another embodiment of activating display 402. Hand 404 is held with the palm or back substantially parallel to display 402 and with index finger 404b and middle finger 404c extended and the remaining fingers retracted. Hand 404 is then moved in a circular or elliptical motion in front of camera 403 to activate the user interface control.

FIG. 4D illustrates an embodiment of a user interface that can be activated with the gestures shown in FIGS. 4A-4C. User interface control 408 is an annulus that is divided into a plurality of sectors numbered 1-8, where each sector represents a different command option. User interface 408 thus provides eight different command options to the user.

FIG. 4E illustrates an embodiment of selecting a command option from user interface 408. To select one of command options 1-8, hand 404 is held with fingers outstretched and the palm or back substantially parallel to display 402. To select a sector, and hence the command option represented by that sector, hand 404 is moved in a direction substantially corresponding to the direction from the center of the annulus to the desired sector. Thus, hand 404 moves in the direction of arrow 4 to select sector 4. As the hand moves in the direction of sector 4, sector 4 gradually fills in until, when it is completely filled in, the command it represents is selected. Similarly, if the user wants to select command option 1, hand 404 is moved in the direction of arrow 1, which substantially corresponds to the direction from the center of the annulus to sector 1. As hand 404 moves toward sector 1, sector 1 gradually fills in until, when it is completely filled in, the command represented by that sector is selected.

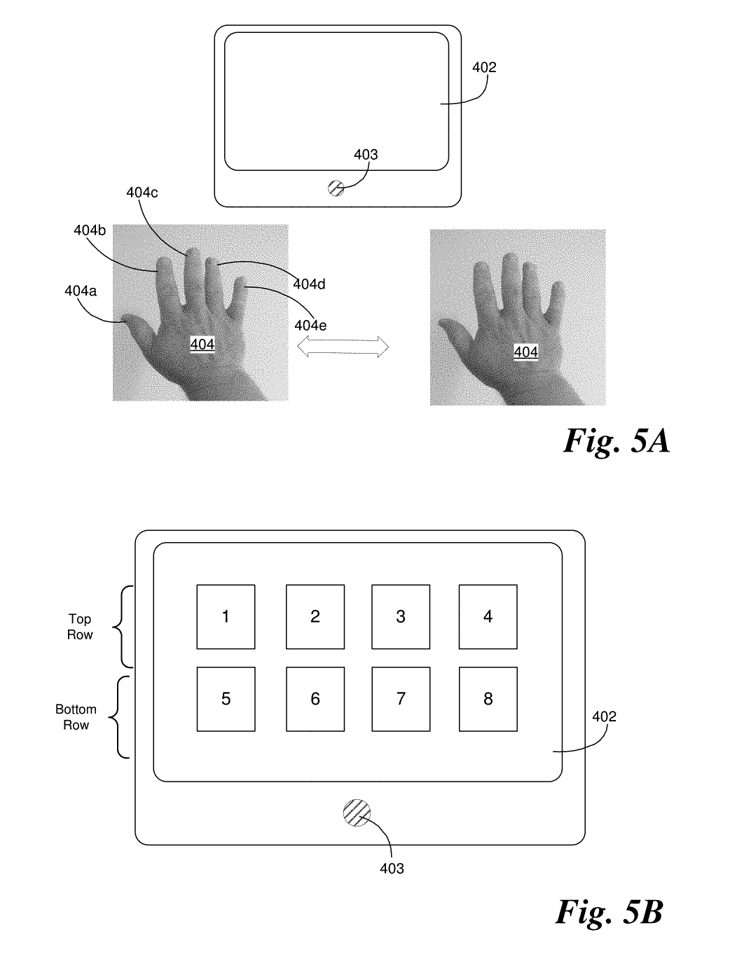

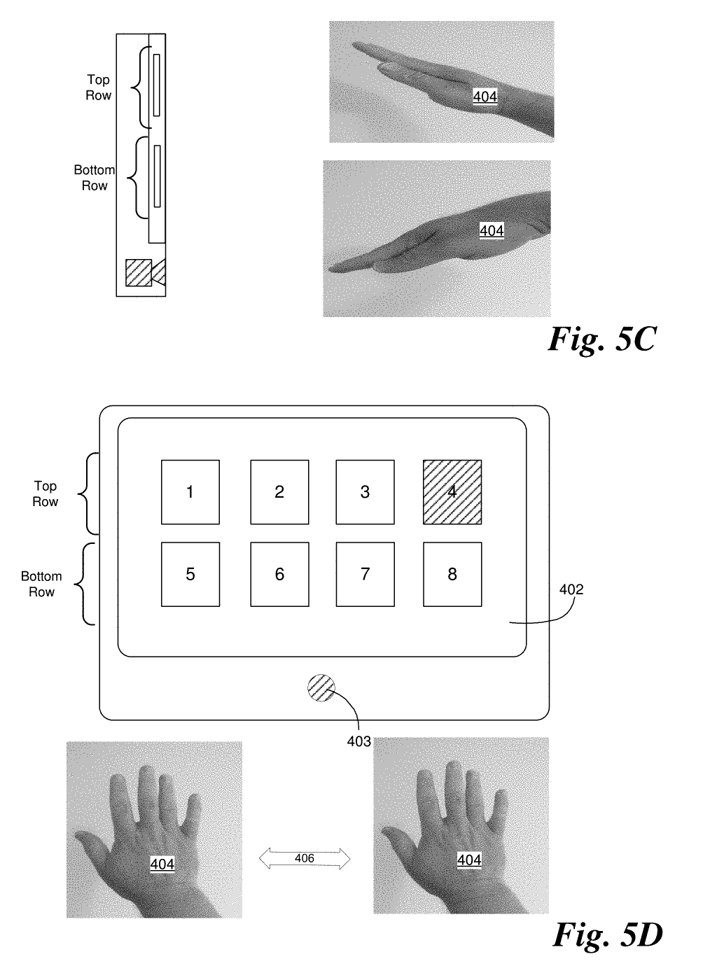

FIGS. 5A-5D illustrate another embodiment of activation of a user interface control and selection of a command option from that user interface control. FIG. 5A illustrates activation of the user interface control by holding hand 404 with all fingers 404a-404e outstretched and the palm or back substantially parallel to display 402 and moving the hand from side to side in the field of view of camera 403 as indicated by the arrow.

FIG. 5B illustrates the user interface control activated by the gesture/motion shown in FIG. 5A. The user interface control includes 2 rows of boxes: a top row comprising boxes numbered 1-4, and a bottom row comprising boxes numbered 5-8. Other embodiments, of course, can have a different number of boxes than shown.

FIG. 5C illustrates selection of one of the rows from the user interface control. To select the top row hand 404 is held with palm flat and fingers extended. The extended fingers are then pointed upward to select the top row or pointed downward to select the bottom row.

FIG. 5D illustrates the selection of a particular box in a particular row in the user interface control of FIG. 5B; in this case, box 4 in the top row. Having selected the top row as shown in FIG. 5C, hand 404 is held in the same gesture and orientation used to select the top row (i.e., upward-pointed fingers) and moved side-to-side to select a particular box within the top row. In the illustrated example, if the user wants to select box 4 hand 404 is moved toward the right side of display 402 until box 4 is highlighted. Once box 4 is highlighted, hand 404 is held motionless to select the box; in other words, the hand is allowed to linger in position until box 4 fills in, indicating that it has been selected.

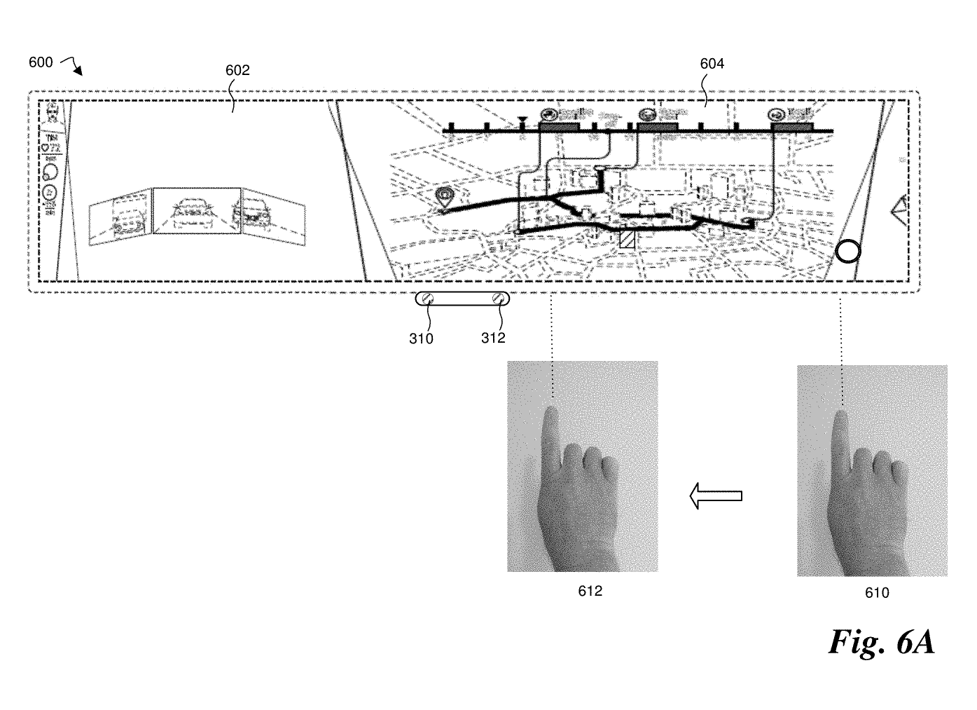

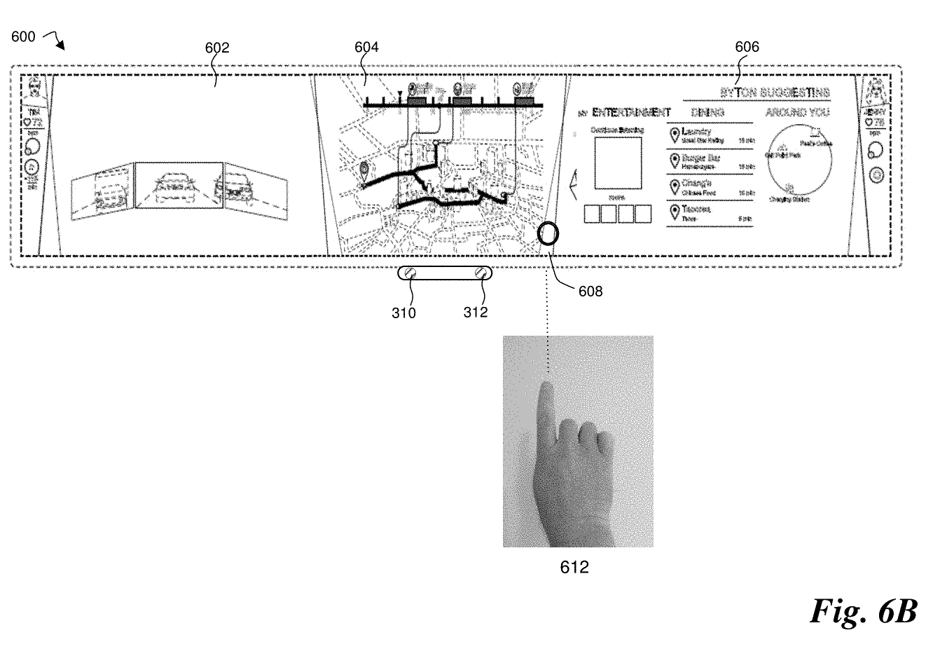

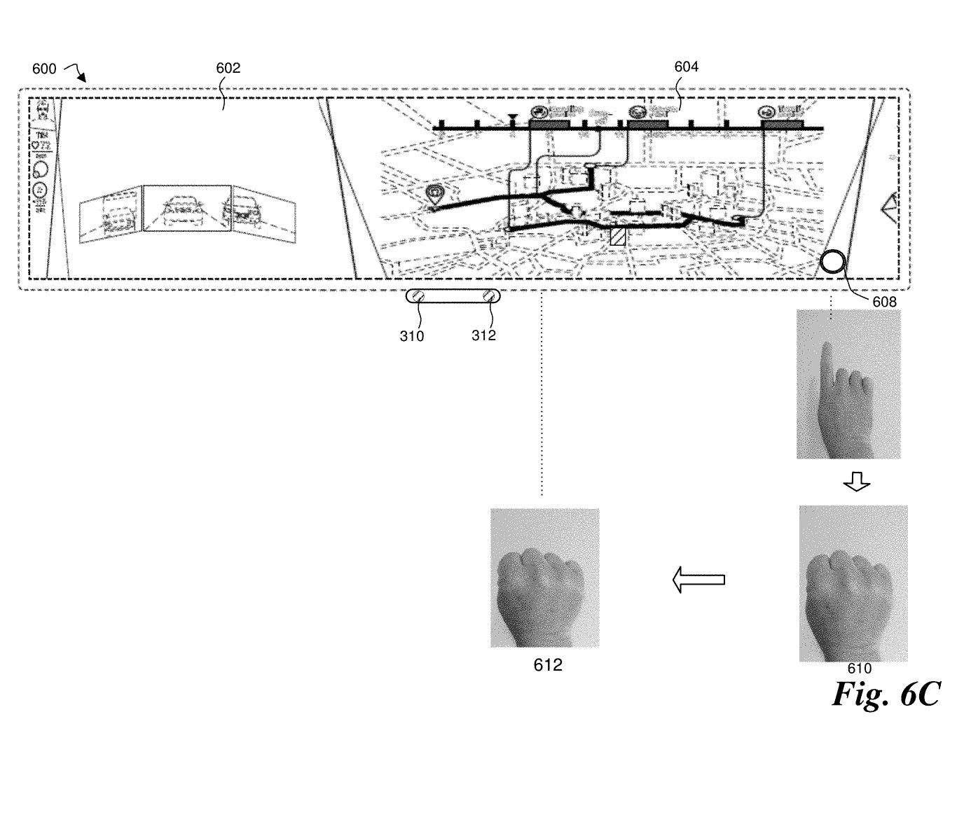

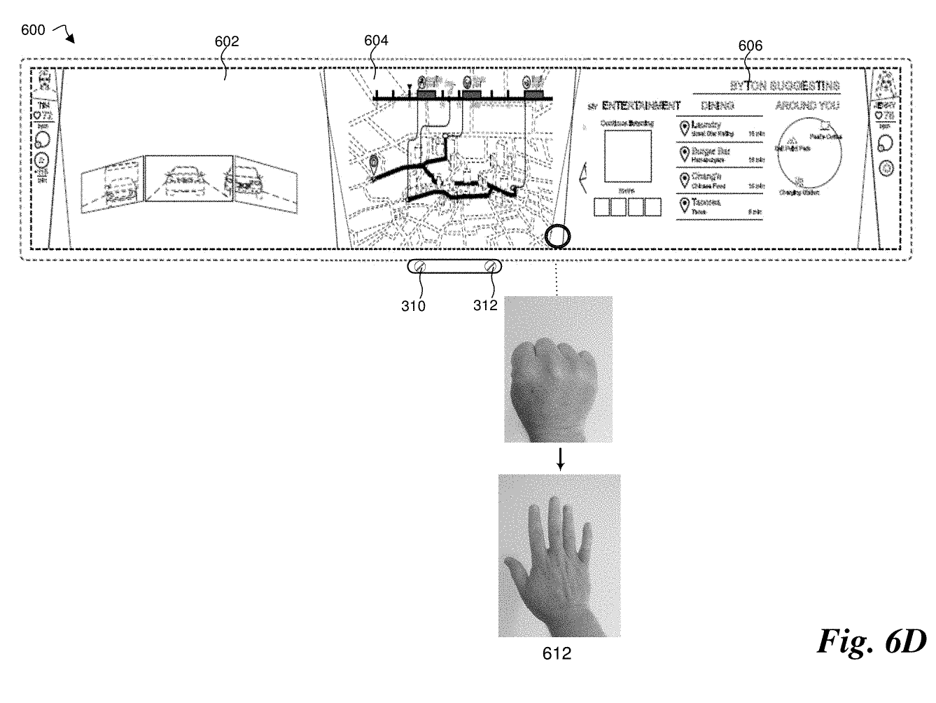

FIGS. 6A-6D illustrate embodiments of gesture interactions that resize the display regions in a software-defined display such as the one shown in FIG. 3B. In the illustrated embodiments, the screen is initially partitioned into two software-defined regions 602 and 604. In the illustrated embodiment, region 602 shows car-related information and an electronic rear-view mirror, while region 604 shows a map display. To create a third software-defined display region 606, the user can use gestures to shrink region 604. FIGS. 6A-6B illustrate a first embodiment. The user first makes a gesture in which they extend their index finger and then they position their hand such that circular cursor, which tracks the motion of the finger in substantially real time, is positioned at a location 610 that roughly corresponds to the location of an inter-region (or intra-display) separator. With the index finger still extended, the user moves their hand from position 610 to position 612. As the hand moves the inter-region separator follows, tracking the hand's motion in substantially real time, and stopping when the hand stops. And as inter-region separator 608 follows, a new software-defined display region 606 appears on one side of it, the right side in this embodiment, When the hand reaches position 612, the user simply lowers the hand to indicate that inter-region separator is now in the desired location and the three display regions are of the desired size (see FIG. 6B).

FIGS. 6C-6D illustrate a second embodiment. The user first makes a gesture in which they extend their index finger and then they position their hand such that circular cursor, which tracks the motion of the finger in substantially real time, is positioned at a location 610 that roughly corresponds to the location of an inter-region (or intra-display) separator 608. To select inter-region separator 608, the user then forms a fist, as if gripping separator 608. With the hand still in a fist, the user moves the fist from position 610 to position 612. As the fist moves the inter-region separator follows, tracking the fist's motion in substantially real time, and stopping when the fist stops. And as inter-region separator 608 follows, a new software-defined display region 606 appears on one side of it, the right side in this embodiment, When the fist reaches position 612, the user simply spreads their fingers into an open hand (see FIG. 6D), thereby releasing their grip on inter-region separator 608 to indicate that inter-region separator is now in the desired location and that display regions 604 and 606 have their desired size.

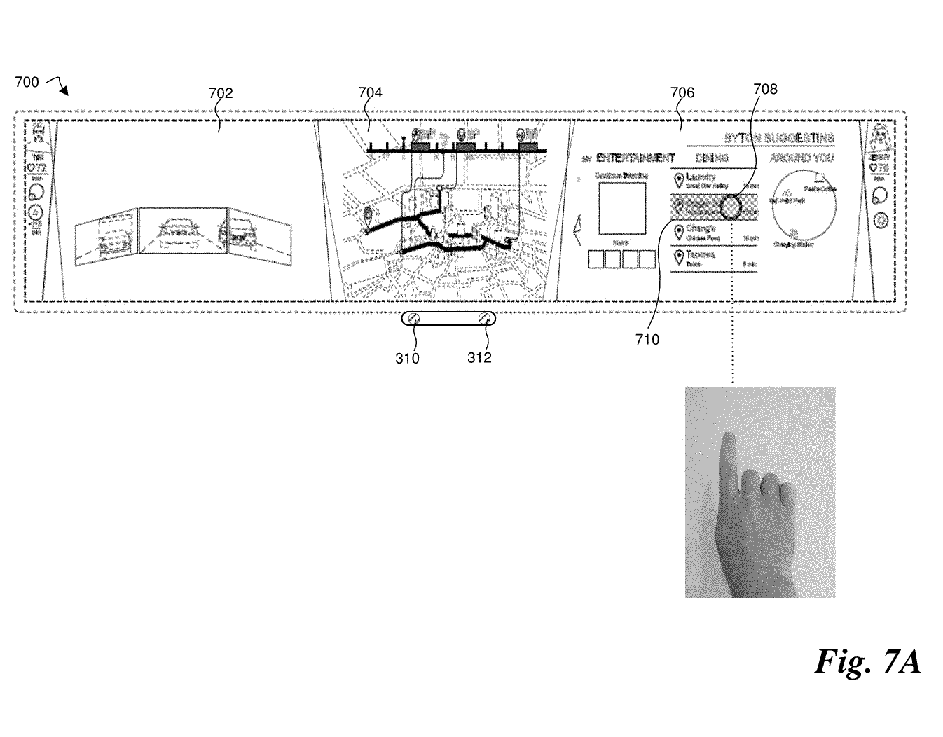

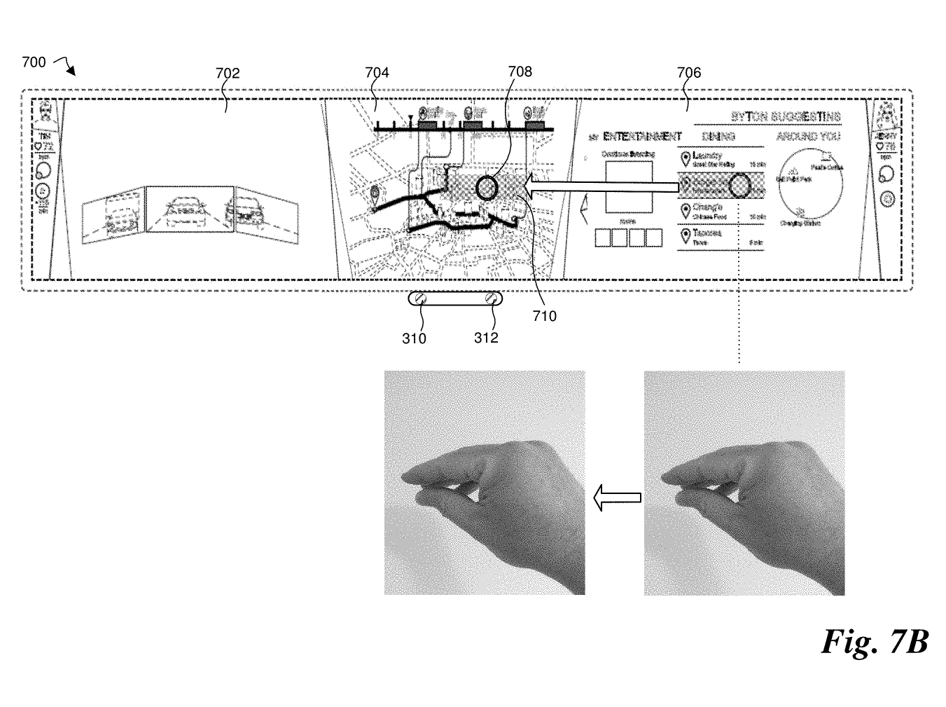

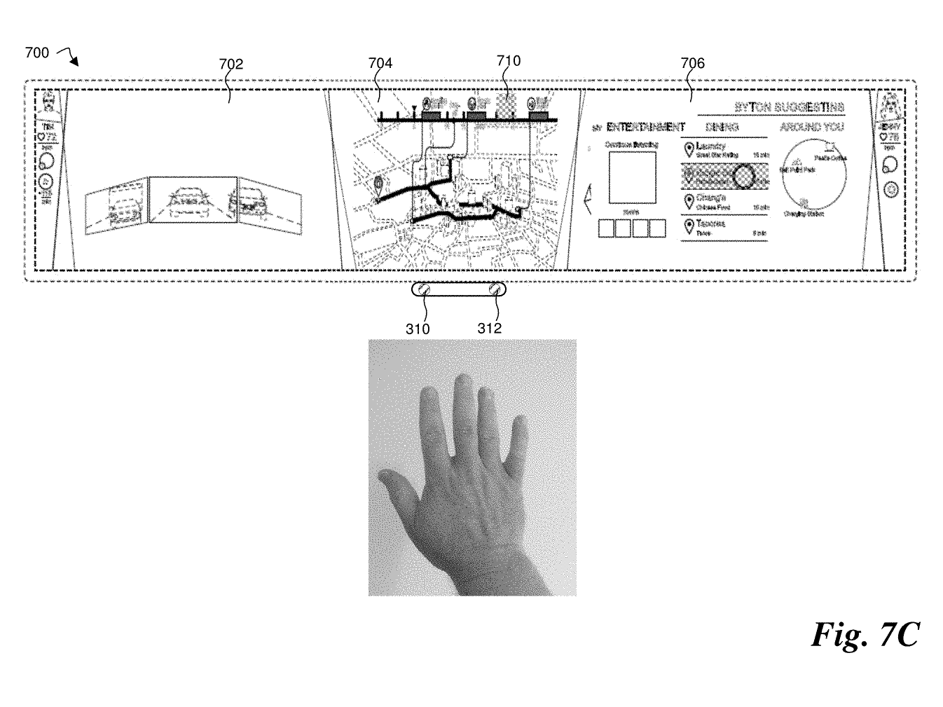

FIGS. 7A-7C together illustrate an embodiment of adding an event from another display region to the map timeline. Display 700 is a display such as the car dashboard display shown in FIG. 3B: it is a unitary display 700 configured to display different things on different software-define display regions 702, 704, and 706. In the illustrated embodiment a map and timeline are displayed in center region 704, while region 706 shows information such as available dining options. If a user wants to add one of the dining options from display region 706 to their schedule, they can use hand gestures and motions to select the desired entertainment event from region 706 and drag it to region 704.

As shown in FIG. 7A, in the illustrated embodiment, the user extends their index finger, causing circular cursor 708 to appear. With the index finger still extended, the user moves their hand and, as the hand moves cursor 708 follows the index finger, tracking the finger's motion in substantially real time, and stopping when the finger stops. When cursor 708 reaches desired item 710, the item highlights. As shown in FIG. 7B, when the desired item highlights the user changes to a pinching gesture, with the index, middle, and possibly the ring and pinky fingers brought together with the thumb, as if grasping the item. With the hand still making the pinching gesture, the user moves their hand toward the map display, as shown by the arrow, and cursor 708 and selected item 710 correspondingly move from display region 706 to display region 708, tracking the hand's motion in substantially real time, as shown by the arrow. As shown in FIG. 7C, the hand stops when cursor 708 and selected item 710 appear on the map. To release selected item 710 onto the map, the user extends all their finger, so that the hand is completely open with the palm facing the display. When released in display region 704, selected item 710 is added to the timeline and all the appropriate user data sources, local or remote, are updated accordingly to include the new event.

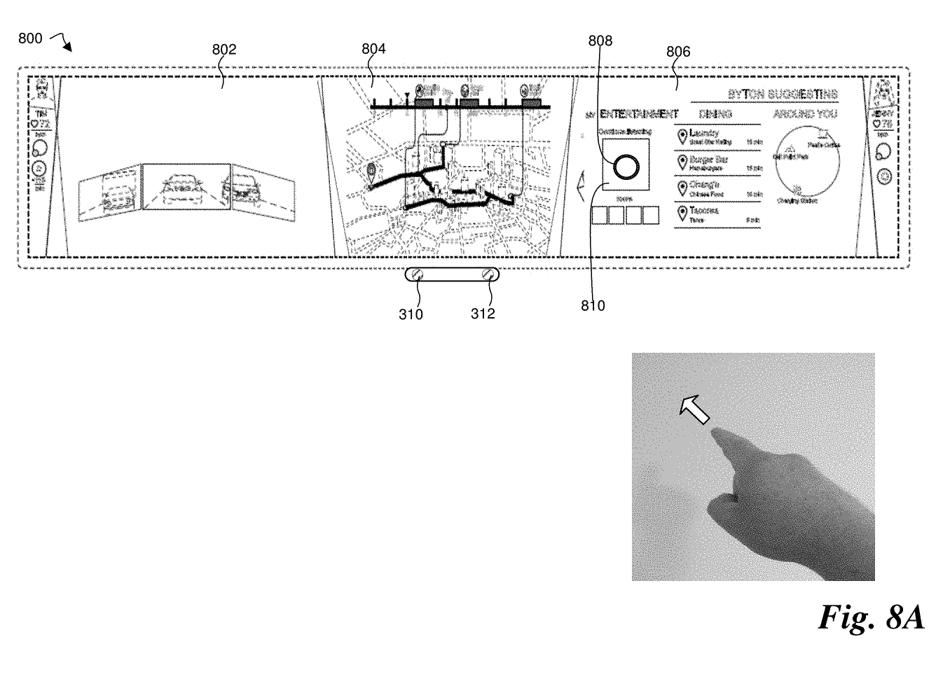

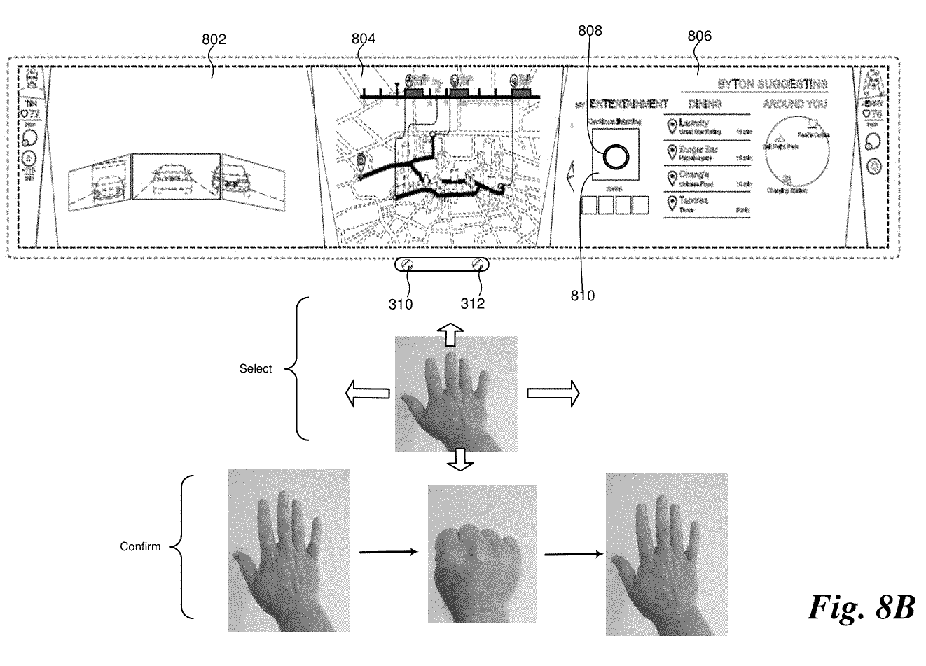

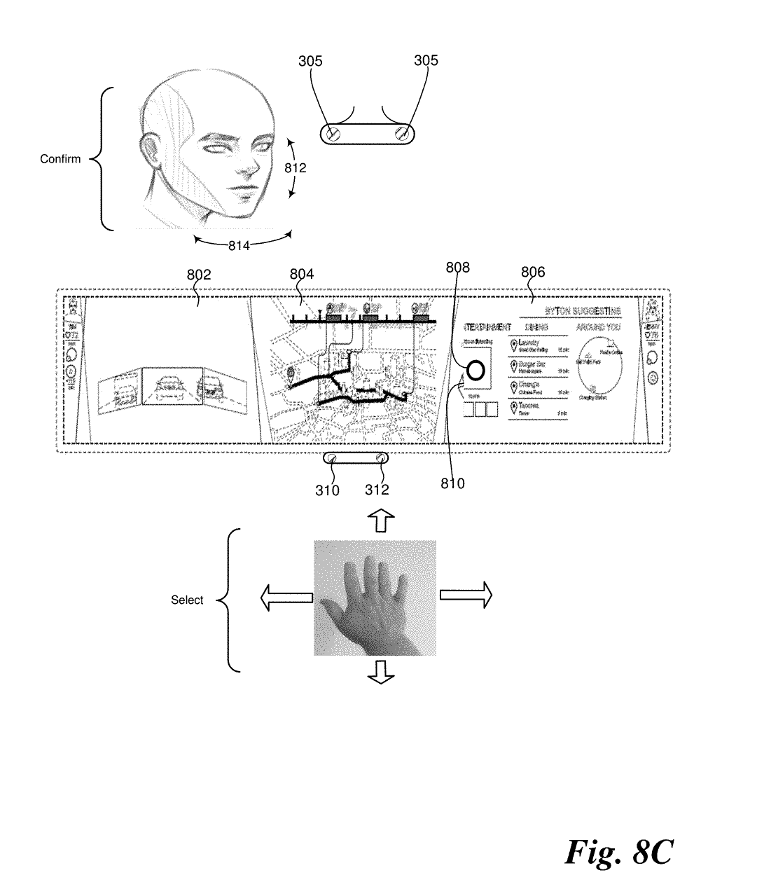

FIG. 8A illustrates an embodiment of a user selecting an item from a display. Display 800 is a single display with three software-definable display regions 802, 804, and 806. Among other things, display region 806 shows entertainment options, such as music that can be played in the car. In the illustrated embodiment, the user extends their index finger and points toward display region 806, causing circular cursor 808 to appear. To select an item from the display the user moves their hand with the index finger still extended and, as the hand moves, cursor 808 follows the index finger, tracking the finger's motion in substantially real time, and stopping when the finger stops. When cursor 808 reaches desired item 810, the user thrusts the hand, or just the index finger, toward the screen—as if trying to poke the screen, as shown by the arrow—to confirm that item 810 is the desired selection.

FIG. 8B illustrates an embodiment of a user selecting an item from display 800. In the illustrated embodiment, the user selects an item by extending the thumb, index, middle, ring, and pinky fingers to form an open hand with the palm facing display region 806, causing circular cursor 808 to appear. To select an item from the display the user moves the hand and, as the hand moves, cursor 808 follows the hand, tracking the hand's motion in substantially real time, and stopping when the hand stops. When cursor 808 reaches desired item 810, the user confirms this item as their selection by quickly closing the hand to a fist, then opening the hand again to return to an open hand with the palm facing the display. Although the illustrated embodiment uses an open hand gesture with all four of the index, middle, ring, and pinky fingers extended, other embodiments need not use all four fingers; a gesture using one, two, or three of these fingers can be used, with the number of fingers that need to be closed to form the confirmation gesture (e.g., closing the hand to form a fist or a pinching gesture) being modified accordingly.

FIG. 8C illustrates an embodiment of a user selecting an item from display 800. In the illustrated embodiment, the user selects an item by extending the thumb, index, middle, ring, and pinky fingers to form an open hand with the palm facing display region 806, causing circular cursor 808 to appear. To select an item from the display the user moves the hand and, as the hand moves, cursor 808 follows the hand, tracking the hand's motion in substantially real time, and stopping when the hand stops. When cursor 808 reaches desired item 810, the user confirms this item as their selection by nodding their head in an up-and-down motion 812 to indicate yes. In an embodiment where the user suggests something to the user, the user can decline the suggestion by shaking their head in a side-to-side motion 814, indicating no. Although the illustrated embodiment uses an open hand gesture with all four of the index, middle, ring, and pinky fingers extended, other embodiments need not use all four fingers; a gesture using one, two, or three of these fingers can be used. Other embodiments can also use different head motions than shown.

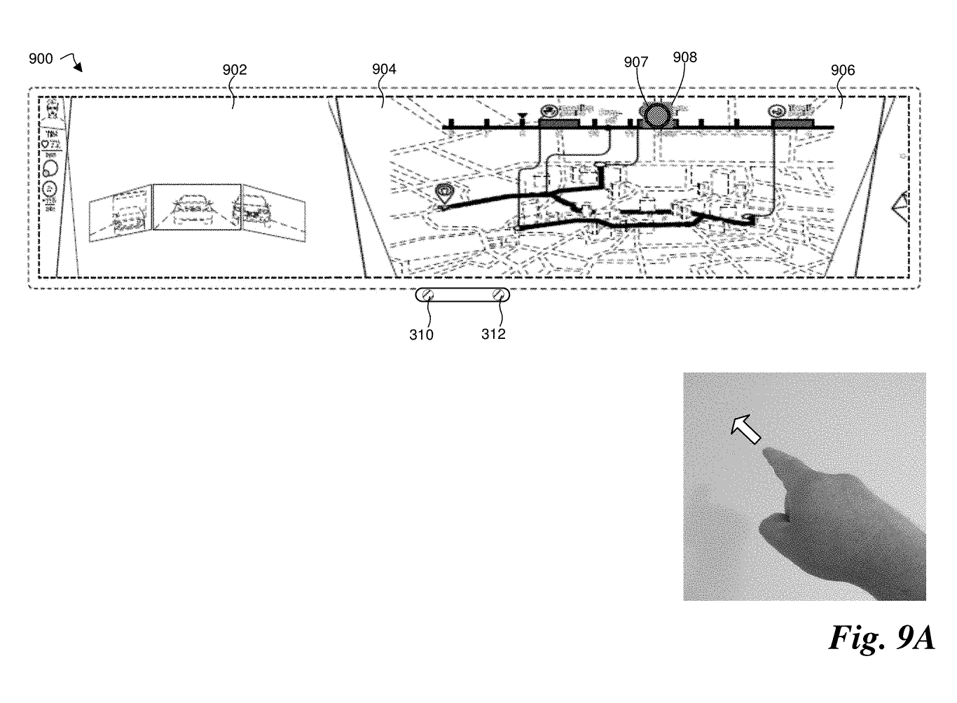

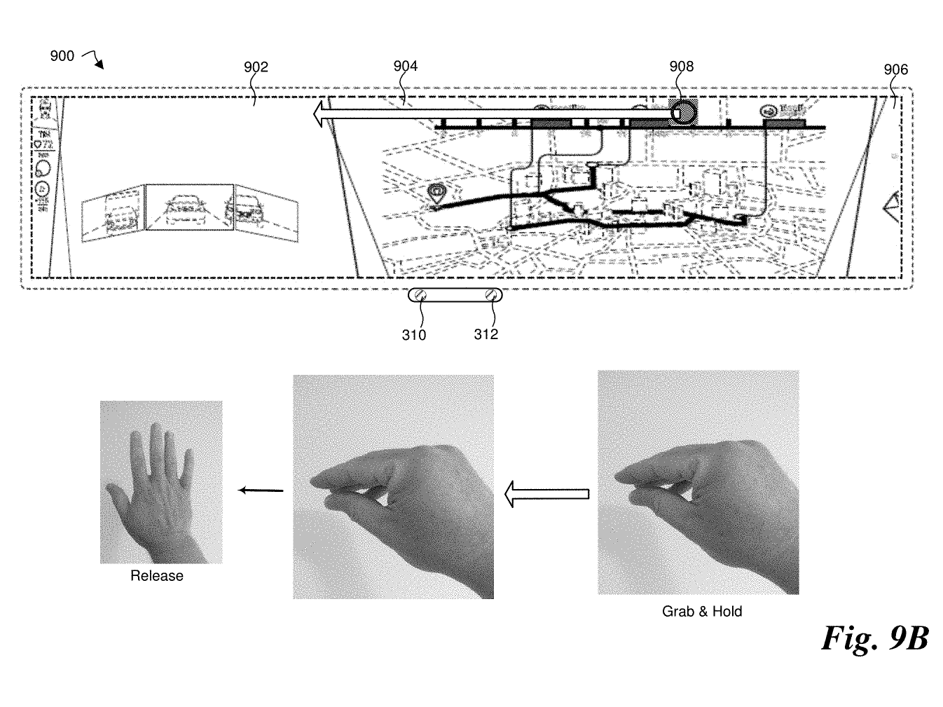

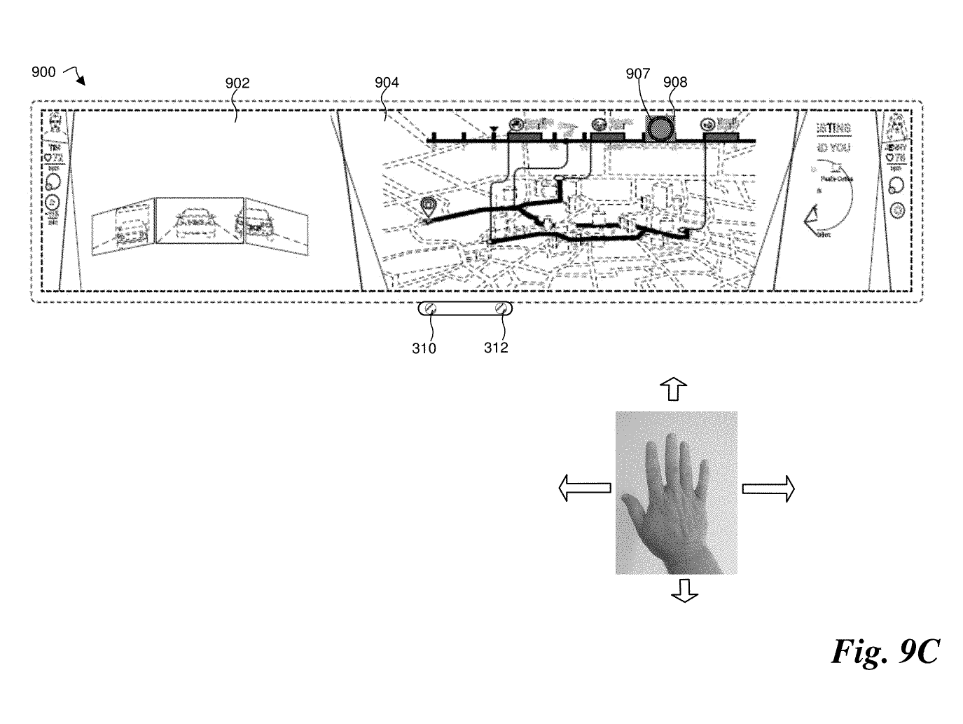

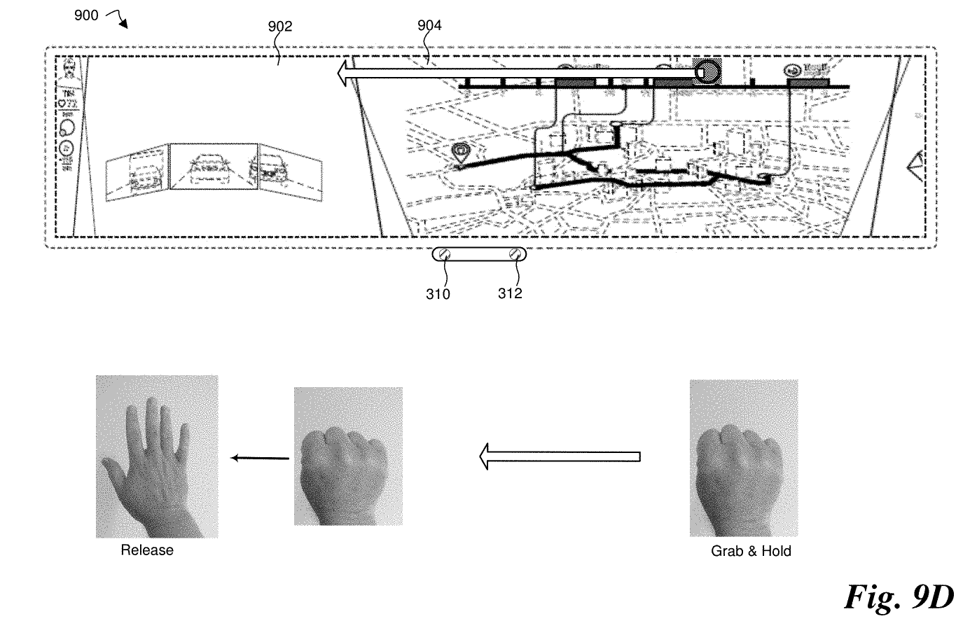

FIGS. 9A-9D illustrate embodiments of selecting and deleting an item from a map timeline. Display 900 is a single display with three software-definable display regions 902, 904, and 906. The map and timeline are shown in center display region 904. FIGS. 9A-9B illustrate a first embodiment. In the illustrated embodiment, the system has suggested event 908 by automatically showing it on the timeline. If the user wants to decline suggested event 908, the user extends their index finger and points toward the timeline in display region 904. With the index finger still extended, the user moves their hand and, as the hand moves circular cursor 907 tracks the finger's motion along the timeline in substantially real time. When circular cursor 907 is over event 908, the user thrusts the hand, or just the index finger, toward the screen—as if trying to poke the screen, as shown by the arrow—to select event 908. Having selected event 908, as shown in FIG. 9B, the user changes to a pinching gesture, with the index, middle, and possibly the ring and pinky fingers brought together with the thumb, as if grasping the item. With the hand still making the pinching gesture, the user moves their hand toward the display region 902, as shown by the arrow, and selected item 908 correspondingly move from display region 904 to display region 902, tracking the hand's motion in substantially real time, as shown by the arrow. As soon event 908 is no longer in display region 904 it is automatically deleted from the timeline and all necessary data sources are uploaded accordingly.

FIGS. 9C-9D illustrate another embodiment. If a user wants to decline suggested event 908, the user extends their thumb, index, middle, ring, and pinky fingers to form an open hand with the palm facing the display. With the hand still open, the user moves their hand and, as the hand moves the hand's motion is tracked by cursor 907 and displayed in substantially real time. As shown in FIG. 9D, when cursor 907 reaches suggested event 908, the user closes the hand to make a fist—as if grabbing suggested event 908—to select event 908. Having selected suggested event 908, the user, with the hand still forming a fist, moves their hand toward the display region 902, thus dragging suggested event 908 toward display region 902. Item 908 correspondingly moves from display region 904 to display region 902, tracking the hand's motion in substantially real time, as shown by the arrow. When event 908 is no longer in display region 904, the user releases the item, thus deleting it, by opening the hand again to return to an open hand with the palm facing the display. Although the illustrated embodiment uses an open hand gesture with the index, middle, ring, and pinky fingers extended, other embodiments need not use all four fingers; a gesture using one, two, or three of these fingers can be used, with the number of fingers that need to be closed to form the selection gesture (e.g., closing the hand to form a fist or a pinching gesture) being modified accordingly.

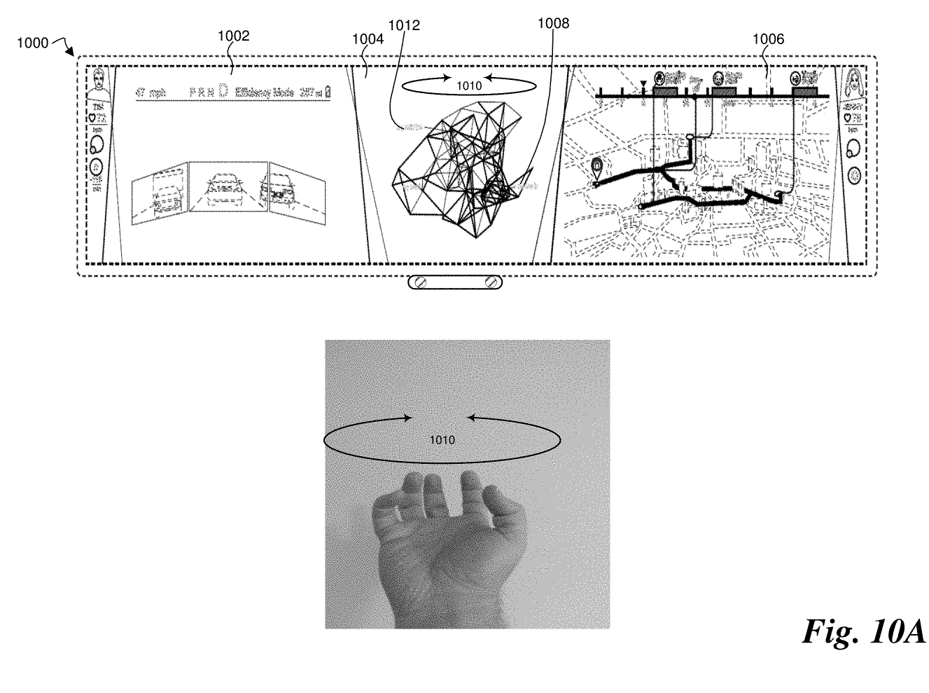

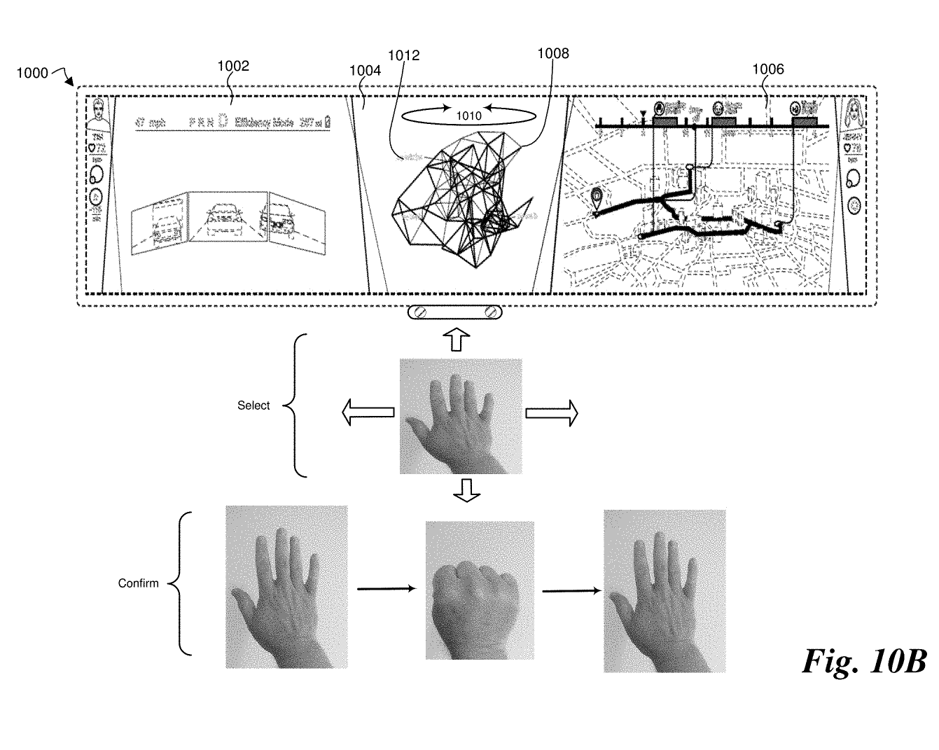

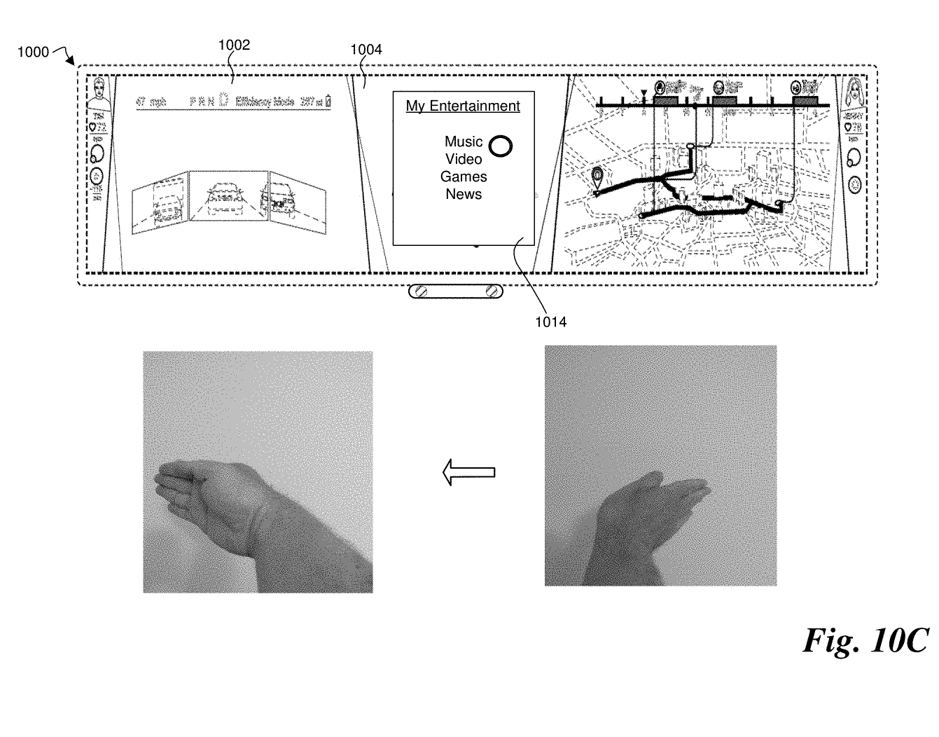

FIGS. 10A-10C illustrate embodiments of a user selecting an item from a display. Display 1000 is a single display with three software-definable display regions 1002, 1004, and 1006. Among other things, display region 1004 shows a three-dimensional user interface object 1008, with various selectable user options 1012 positioned around it. FIG. 10A illustrates an embodiment. In the illustrated embodiment, the user holds their hand in a cradling position, as if cradling object 1008. With the hand still in the cradling position, the user rotates the hand and, as the hand rotates, object 1008 follows the hand rotation, tracking the hand's motion in substantially real time, and stopping when the hand stops. When object 1008 is stops with a particular user option positioned in front (i.e., appearing closest to the user), that option is automatically selected.

FIG. 10B illustrates another embodiment. In this embodiment, the user holds their hand with the thumb, index, middle, ring, and pinky fingers extended, so that the hand is open with the palm facing the display. With the hand open, the user then moves their hand up and down or side-to-side and, as the hand moves, the rotation of three-dimensional interface object 1008 follows the hand movement, tracking the hand's motion in substantially real time, and stopping when the hand stops. When the user has the desired selectable user option 1012 in the front (i.e., appearing closest to the user), the user then confirms that option 1012 as their selection by quickly closing the hand to a fist, then opening the hand again to return to an open hand with the palm facing the display. Although the illustrated embodiment uses an open hand gesture with the index, middle, ring, and pinky fingers extended, other embodiments need not use all four fingers; a gesture using one, two, or three of these fingers can be used, with the number of fingers that need to be closed to form the confirmation gesture (e.g., closing the hand to form a fist or a pinching gesture) being modified accordingly.

FIG. 10C illustrates an embodiment of a gesture for reversing an action. In the illustrated embodiment the user has selected a user option 1012 from three-dimensional user interface object 1008. Selection of that item has caused a menu 1014 to appear. But if upon reviewing menu 1014 the user finds that what they wanted does not appear in the menu, they can return to three-dimensional user interface object 1008 by holding their hand open—with the thumb, index, middle, ring, and pinky fingers extended so that the palm faces sideways—and making a swiping motion, as if slapping something. In the illustrated embodiment the hand motion is from right to left, with some acceleration of the hand during the motion. But in other embodiments the hand motion can be from left to right. Although illustrated in the context of three-dimensional user interface object 1008 and associated menus, the illustrated gesture can be used in any contact in which the user wishes to reverse an action to return to a previous state. Although the illustrated embodiment uses an open hand gesture with the index, middle, ring, and pinky fingers extended, other embodiments need not use all four fingers; a gesture using one, two, or three of these fingers can be used.

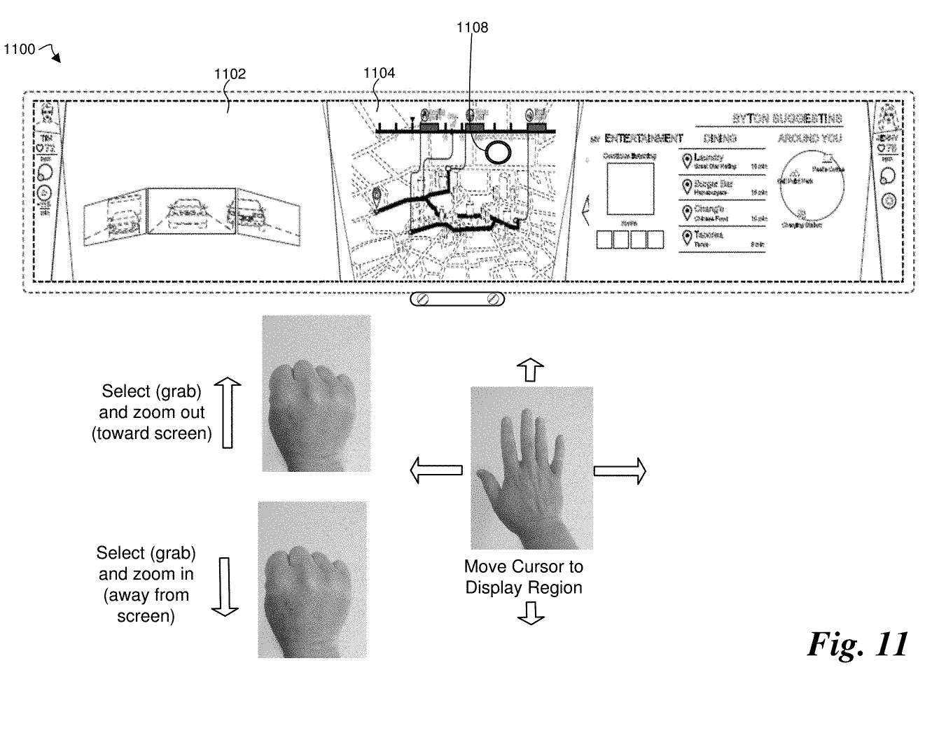

FIG. 11 illustrates an embodiment of gestures and motions that can be used to modify the appearance of items on a display, for instance by making them appear larger (i.e., zooming in) or smaller (i.e., zooming out). In the illustrated embodiment the user extends their thumb, index, middle, ring, and pinky fingers to form an open hand with the palm facing the display. With the hand still open, the user moves their hand and, as the hand moves the hand's motion is tracked and displayed by cursor 1108 in substantially real time. When cursor 1108 is in the display region in which the user wants to zoom in or out (center display region 1104 with a map display in this embodiment), the user closes the hand to make a fist—as if grabbing display region 1104—to select it. Having selected display region 1104 the user, with their hand still forming a fist, moves their hand toward display region 1104 (i.e., toward the screen and/or the gesture camera), to enlarge (i.e., zoom in on) what is shown in the display, or moves their hand away from display region 1104 (i.e., away from the screen and/or the gesture camera), to make smaller (i.e., zoom our of) what is shown in the display.

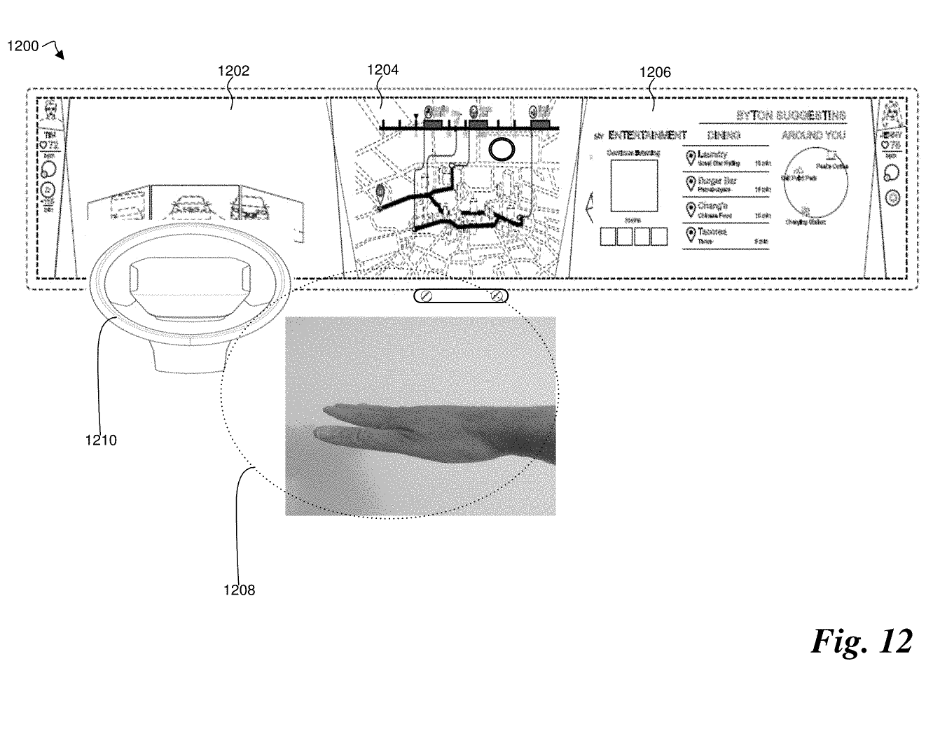

FIG. 12 illustrates an embodiment of gestures and motions that can be used to activate or deactivate the gesture recognition system. In some instances, it can be useful for the gesture recognition system not to be active all the time. In a car, for instance, the driver and passenger might use many hand gestures and motions during a conversation, but might not intend for those gestures or motions to be seen or interpreted by the gesture recognition system. If the gesture recognition does see and interpret these gestures or motions, it could cause setting, selections, etc., to be inadvertently modified or it could cause items on a display to move around constantly, causing driver distraction. To prevent this, the system can be deactivated or, if not fully deactivated, set to where it doesn't show display motions that result from gestures. As a result, it can be necessary to have gestures and motions that partially or fully activate or deactivate the system.

In the illustrated embodiment, the system can examine an area 1208 for a specified time period and, if it sees no gestures or motions in the area for the specified time period it can partially or fully deactivate the gesture recognition. Alternatively, the gesture recognition system can be partially or fully deactivated by another event, such as when a hand touches steering wheel 1210. If the gesture recognition system has been partially or fully deactivated, it can be reactivated by the user by extending the thumb, index, middle, ring, and pinky fingers to form an open hand with the palm facing downward. This gesture is then held substantially stationary for a fixed period to activate the display.

The particular gestures, motions, and user interfaces illustrated in the preceding figures are not intended to be limiting. Many other gestures, motions, and user interfaces are possible in other embodiments and are encompassed herein. In other embodiments gestures and motions can include:
Moving a hand towards the ceiling causes the menu to be displayed.
The user uses his fingers to rotate the menu.
Moving a hand towards and away from the display screen with the fingers in a certain configuration can control spin. In one mode, the display shows an image of the user's hand that tracks the hand movement.
The user can grab and drag an icon or file to a different display screen defined area or even to screens in the back of the car.
A gesture that lingers over an area of the screen for a defined time replaces the click in order to choose an option or an app.
If the user draws a circle with his hand, then a circle with boxes of selection options is displayed.
If a gesture lingers over a box, the box progressively fills in and then is selected once it becomes solid in color.
Moving the hand closer to the screen speeds up the linger time activation.
Another variation is a horizontal display of boxes of selection options. For that variation, a circle is displayed to show the linger/wait time, with the rim of the circle progressively highlighted in a clockwise direction over time. The user can alternate between selecting items with lingering gestures or using a touch pad.

The above description of embodiments, including what is described in the abstract, is not intended to be exhaustive or to limit the invention to the described forms. Specific embodiments of, and examples for, the invention are described herein for illustrative purposes, but various equivalent modifications are possible within the scope of the invention in light of the above detailed description, as those skilled in the relevant art will recognize.

What is claimed is:

1. An apparatus comprising:
a digital camera to capture video or a sequence of still images of a user's hand;
one or more processors coupled to the digital camera to process the video or the sequence of still images to produce a digital representation of the user's hand, to determine the gesture and motion of the user's hand from the digital representation, and to correlate the gestureor the gesture/motion combination to a user interface command;
a user interface controller coupled to receive the user interface command from the one or more processors; and
a display coupled to the user interface controller, wherein the user interface controller causes a set of one or more user interface controls to appear on the display, wherein the user interface command selects or adjusts one or more of the set of displayed user interface controls, and wherein motion of the selected user interface control tracks the motion of the user's hand in substantially real time.

2. The apparatus of claim 1, further comprising one or more systems coupled to the user interface controller, wherein selection or adjustment of one or more of the displayed user interface controls selects or adjusts attributes of the one or more systems.

3. The apparatus of claim 1 wherein the set of displayed user interface controls are context specific.

4. The apparatus of claim 1 wherein the digital camera is a stereoscopic camera or a time-of-flight camera.

5. The apparatus of claim 1, further comprising a user feedback mechanism coupled to the one or more processors.

6. The apparatus of claim 5 wherein the user feedback mechanism comprises a tapping mechanism positioned to tap a part of the user's body.

7. The apparatus of claim 6 wherein the tapping mechanism provides feedback to the user if the gesture, the motion, or the gesture and the motion cannot be correlated to the user interface command by the one or more processors.

8. The apparatus of claim 1 wherein the user interface controller displays the digital representation of the hand on the display.

9. The apparatus of claim 1, further comprising at least one additional display coupled to the user interface controller.

10. The apparatus of claim 1 wherein the gesture/motion combination comprises:
a first gesture/motion combination to activate a user interface element comprising an annulus divided into a plurality of sectors, each sector corresponding to a user interface command;
a second gesture combined with motion in the direction of a particular sector to select the user interface command represented by that sector.

11. The apparatus of claim 10 wherein the particular sector fills in proportionately to the motion of the second gesture and activates the user interface command upon becoming completely filled in.

12. The apparatus of claim 10 wherein the first gesture/motion combination is one of:
an extended index finger moved in a circular motion;
extended index and middle fingers moved in a circular motion; and
an open palm with all fingers fully extended so that the hand is substantially parallel to the screen and moved in a circular motion.

13. The apparatus of claim 12 wherein the second gesture is an open palm with all fingers fully extended so that the hand is substantially parallel to the screen.

14. The apparatus of claim 1 wherein the gesture/motion combination comprises:
a first gesture/motion combination to activate a user interface element comprising multiple rows of two-dimensional or three-dimensional blocks, each block corresponding to a user interface command;
a second gesture combined with motion in the direction of a particular row and a particular block to select the user interface command represented by that block.

15. The apparatus of claim 14 wherein the first gesture/motion combination an open palm with all fingers fully extended so that the hand is substantially parallel to the screen and moved in a side-to-side motion.

16. The apparatus of claim 15 wherein the second gesture is an open palm with all fingers fully extended so that the fingers point substantially toward the screen and the motion is:
pointing the hand up or down to select a row;
moving the hand side-to-side to select a block within a row; and
lingering over a particular block to select that particular block.

17. A system comprising:
an automobile including a driver's seat, one or more passenger seats, and a dashboard having a dashboard display therein;
a gesture and motion recognition system comprising:
a digital camera to capture video or a sequence of still images of a driver's hand,
one or more processors coupled to the digital camera to process the video or the sequence of still images to produce a digital representation of the driver's hand, to determine the gesture and motion of the driver's hand from the digital representation, and to correlate the gesture or the gesture/motion combination to a user interface command,
a user interface controller coupled to receive the user interface command from the one or more processors; and
a display coupled to the user interface controller, wherein the user interface controller causes a set of one or more user interface controls to appear on the display, wherein the user interface controller uses the user interface command to select or adjust one or more of the set of displayed user interface controls, and wherein motion of the selected user interface control tracks the motion of the user's hand in substantially real time.

18. The system of claim 17, further comprising one or more systems coupled to the user interface controller, wherein selection or adjustment of one or more of the displayed user interface controls selects or adjusts attributes of the one or more systems.

19. The system of claim 18 wherein the one or more systems include a sound system, a navigation system, a telephone system, or a car system.

20. The system of claim 17, further comprising a passenger camera and a passenger display for each passenger seat, each passenger camera being coupled to the one or more processors and each passenger display being coupled to the user interface controller.

21. The system of claim 20 wherein the passenger display for each rear passenger seat is located in the back of the corresponding front seat.

22. The system of claim 20 wherein each rear seat passenger display comprises a fixture into which a tablet computer can be secured and electrically connected to provide the display, wherein the fixture includes the passenger camera and an additional facial camera.

23. The system of claim 20 wherein the digital camera and the passenger cameras are stereoscopic cameras or time-of-flight cameras.

24. The system of claim 17, further comprising a user feedback mechanism coupled to the one or more processors.

25. The system of claim 24 wherein the user feedback mechanism comprises a tapping mechanism positioned in the back of the driver's seat.

26. The system of claim 25 wherein the tapping mechanism provides feedback to the user if the gesture, the motion, or the gesture and the motion are unrecognized by the one or more processors.

27. The system of claim 17 wherein the user interface controller displays the digital representation of the hand on the display.

28. The system of claim 17 wherein the gesture/motion combination comprises:
a first gesture/motion combination to activate a user interface element comprising an annulus divided into a plurality of sectors, each sector corresponding to a user interface command;
a second gesture combined with motion in the direction of a particular sector to select the user interface command represented by that sector.

29. The system of claim 28 wherein the particular sector fills in proportionately to the motion of the second gesture and activates the user interface command upon becoming completely filled in.

30. The system of claim 28 wherein the first gesture/motion combination is one of:
an extended index finger moved in a circular motion;
extended index and middle fingers moved in a circular motion; and
an open palm with all fingers fully extended so that the hand is substantially parallel to the screen and moved in a circular motion.

31. The system of claim 30 wherein the second gesture is an open palm with all fingers fully extended so that the hand is substantially parallel to the screen.

32. The system of claim 17 wherein the gesture/motion combination comprises:
a first gesture/motion combination to activate a user interface element comprising multiple rows of two-dimensional or three-dimensional blocks, each block corresponding to a user interface command;
a second gesture combined with motion in the direction of a particular row and a particular block to select the user interface command represented by that block.

33. The system of claim 32 wherein the first gesture/motion combination an open palm with all fingers fully extended so that the hand is substantially parallel to the screen and moved in a side-to-side motion.

34. The system of claim 33 wherein the second gesture is an open palm with all fingers fully extended so that the fingers point substantially toward the screen and the motion is:
pointing the hand up or down to select a row;
moving the hand side-to-side to select a block within a row; and
lingering over a particular block to select that particular block.

35. A method comprising:
capturing video or a sequence of still images of a user's hand;
processing the video or the sequence of still images to produce a digital representation of the user's hand, to determine the gesture and motion of the user's hand from the digital representation, and to correlate the gesture or the gesture/motion combination to a user interface command;
causing a set of one or more user interface controls to appear on a display, wherein the user interface command selects or adjusts one or more of the set of displayed user interface controls, and wherein motion of the selected user interface control tracks the motion of the user's hand in substantially real time.

36. The method of claim 35 wherein selecting or adjusting one or more of the displayed user interface controls selects or adjusts attributes of the one or more systems.

37. The method of claim 35 wherein the set of displayed user interface controls are context specific.

38. The method of claim 35, further comprising providing haptic feedback to a user.

39. The method of claim 38 wherein the haptic feedback comprises tapping a part of the user's body.

40. The method of claim 39 wherein feedback is provided to the user if the gesture, the motion, or the gesture and the motion cannot be correlated to the user interface command.

41. The method of claim 35 wherein the gesture/motion combination comprises:
a first gesture/motion combination to activate a user interface element comprising an annulus divided into a plurality of sectors, each sector corresponding to a user interface command;
a second gesture combined with motion in the direction of a particular sector to select the user interface command represented by that sector.

42. The method of claim 41 wherein the particular sector fills in proportionately to the motion of the second gesture and activates the user interface command upon becoming completely filled in.

43. The method of claim 42 wherein the first gesture/motion combination is one of:
an extended index finger moved in a circular motion;
extended index and middle fingers moved in a circular motion; and
an open palm with all fingers fully extended so that the hand is substantially parallel to the screen and moved in a circular motion.

44. The method of claim 43 wherein the second gesture is an open palm with all fingers fully extended so that the hand is substantially parallel to the screen.

45. The method of claim 35 wherein the gesture/motion combination comprises:
a first gesture/motion combination to activate a user interface element comprising multiple rows of two-dimensional or three-dimensional blocks, each block corresponding to a user interface command;
a second gesture combined with motion in the direction of a particular row and a particular block to select the user interface command represented by that block.

46. The method of claim 45 wherein the first gesture/motion combination an open palm with all fingers fully extended so that the hand is substantially parallel to the screen and moved in a side-to-side motion.

47. The method of claim 46 wherein the second gesture is an open palm with all fingers fully extended so that the fingers point substantially toward the screen and the motion is:
pointing the hand up or down to select a row;
moving the hand side-to-side to select a block within a row; and
lingering over a particular block to select that particular block.
